(19) United States
(12) Patent Application Publication
(10) Pub. No.: US 2004/0115995 A1
(43) Pub. Date: Jun. 17, 2004

(54) Circuit array module

(76) Inventor: Samuel Sidney Sanders, Gainesville, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(21) Appl. No.: 10/720,930

(22) Filed: Nov. 24, 2003

Related U.S. Application Data
(60) Provisional application No. 60/429,062, filed on Nov. 25, 2002.

(51) Int. Cl. H01R 13/502

(52) U.S. Cl. 439/701

(57) ABSTRACT

Circuit array modules that can be assembled into one, two or three dimensional modular circuit arrays. Modules can include a straightforward location mechanism for determining the location of the circuit array modules within a modular circuit array. Modules allow multiple configurations to be stored in non-volatile memory a pre-determined configuration can be loaded upon power-up or reset based upon a number of factors, including the location of the circuit array module within a modular circuit array and/or the location, type and/or connection position of adjacent circuit array modules. A software system a workstation connects to a modular circuit array and allows the determination of the components of the modular circuit array, programming or configuration of some or all of the circuit array modules within the modular circuit array, and observation/control of the modular circuit array while executing an processing program or routine.

### CROSS-REFERENCED APPLICATIONS

This non-provisional application is a continuation-in-part of the provisional patent application serial No. 60/429,062 with inventor Samuel Sidney Sanders entitled “RECONFIGURABLE MODULAR ARRAY” filed Nov. 25, 2002, which is hereby incorporated by reference in its entirety.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### BACKGROUND OF THE INVENTION

1. Field of the Invention

The present invention generally relates to the field of circuit modules and more particularly to interconnecting circuit modules that can be interactively combined.

2. Background of the Invention

Modular circuit arrays, which are assemblies of a number of interoperating circuit array modules, have many applications in the area of research, development, prototyping and other applications. For example, one or a number of standard building blocks can be constructed and assembled into a modular circuit array to facilitate testing and evaluating a new circuit design. Each of these circuit array modules that make up a modular circuit array is able to have a special purpose or some or all of these circuit array modules can be reconfigurable and adapted to various purposes.

Modular circuit arrays sometimes include circuit array modules that include a programmable processor, such as a microcomputer, or a reprogrammable logic circuit, such as an FPGA. Assembling a number of such circuit array modules allows a more complex circuit to be realized than would be realizable in a single module. Using a standard, or at least already constructed, circuit array module allows faster construction of a test and evaluation platform that would be possible if a test and evaluation platform had to be constructed from scratch. Interchangeable modules further allow rapid and easy modification of prototype circuits to allow evaluation of alternative and/or different designs.

Current modular circuit arrays allow circuit array modules to be connected to one another by using pre-defined arrangements. Each module within these modular circuit arrays is required to be configured and connected to one or more adjacent circuit array modules according to the pre-defined configuration. Modification of the arrangement of the circuit array modules in such a modular circuit array requires redesign of one or more of the circuit array modules to accommodate this re-arrangement. This severely limits the flexibility and applicability of modular circuit arrays to prototyping, testing and evaluation of prototype designs.

Therefore a need exists to overcome the problems with the prior art as discussed above.

### SUMMARY OF THE INVENTION

According to a preferred embodiment of the present invention, a circuit array module for interconnection with similar circuit array modules includes a module body comprising an electrical circuit, a top surface, a bottom surface, and four lateral surfaces. At least one top connector is located on the top surface, at least one bottom connector is located on the bottom surface, and at least three side connectors that are each located on a different surface of the four lateral surfaces. Each of the at least one top connector, the at least one bottom connector and the at least four side connectors are suitable for connecting to an adjacent connector that is mounted on an opposite surface of a similar module body.

According to another aspect of the present invention, a circuit array module includes a module body comprising a processor and configuration storage for storing a plurality of configuration definitions. The at least two of the plurality of configuration definitions define different configurations for the processor and each configuration definition within the plurality of configuration definitions is also associated with a specified identity. The circuit array module further includes an attribute detector for determining an attribute of the module body and a configuration selector for selecting a selected configuration definition from the plurality of configuration definitions depending on the attribute.

In another aspect of the present invention, a method for defining a plurality of circuit configurations for a reconfigurable module includes defining a first circuit configuration of a circuit for a first reconfigurable module. The first reconfigurable module is able to connect to a second reconfigurable module at more than one of a plurality of locations and the first circuit configuration also depends upon the second reconfigurable module being connected to the first reconfigurable module at a first location within the plurality of locations. The method further includes defining a second circuit configuration of the circuit for the first reconfigurable module. The second circuit configuration depends upon the second reconfigurable module being connected to the first reconfigurable module at a second location within the plurality of locations.

### BRIEF DESCRIPTION OF THE DRAWINGS

The accompanying FIGUREs, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an isometric view of a circuit array module according to an exemplary embodiment of the present invention.

FIG. 2 is an interconnection diagram of connections between the circuit array module as illustrated in FIG. 1 and adjacent circuit array modules when forming a modular circuit array according to a preferred embodiment of the present invention.

FIG. 3 illustrates signal interconnections among a number of circuit array modules that are assembled into a partial modular circuit array according to a preferred embodiment of the present invention.

FIG. 4 illustrates signal interconnections among a number of circuit array modules that are assembled into a fully populated three-dimensional cube modular circuit array according to a preferred embodiment of the present invention.

FIG. 5 illustrates electrical interconnections among a number of circuit, array modules that are assembled into a fully populated, three-dimensional cube modular circuit array according to a preferred embodiment of the present invention.

FIG. 6 is a schematic diagram that illustrates electrical connections within a circuit array module according to a preferred embodiment of the present invention.

FIG. 7 is a schematic diagram that illustrates electrical connections and interconnections within and among a number of circuit array modules that are assembled into a fully populated, two dimensional modular circuit array according to a preferred embodiment of the present invention.

FIG. 8 is a schematic diagram that illustrates a single dimension module location determination circuit as incorporated into a preferred embodiment of the present invention.

FIG. 9 is a schematic diagram that illustrates a cascade of module location determination circuits in one dimension according to an exemplary embodiment of the present invention.

FIG. 10 is a schematic diagram that illustrates a five input module location determination circuit to for use in a circuit array module supporting connections to adjacent modules in three dimensions, according to a preferred embodiment of the present invention.

FIG. 11 is a schematic diagram that illustrates interconnections among module location determination circuits located on a number of circuit array modules as are used to determine module circuit array module location in a single dimension, according to a preferred embodiment of the present invention.

FIG. 12 is a schematic diagram for a three-dimensional module location determination circuit as incorporated into a circuit array module supporting connections to adjacent modules in three dimensions, according to a preferred embodiment of the present invention.

FIG. 13 is a processing flow diagram for power on reset processing of a circuit array module, according to a preferred embodiment of the present invention.

FIG. 14 is a processing flow diagram for configuration selection processing of a circuit array module as performed during the power on processing shown in FIG. 13, according to a preferred embodiment of the present invention.

FIG. 15 is a processing flow diagram for idle time processing of a circuit array module as performed during the power on processing shown in FIG. 13, according to a preferred embodiment of the present invention.

FIG. 16 is a processing flow diagram for broadcast message receive processing of a circuit array module as performed during the power on processing shown in FIG. 13, according to a preferred embodiment of the present invention.

FIG. 17 is a processing flow diagram for received message routing processing of a circuit array module as performed during the power on processing shown in FIG. 13, according to a preferred embodiment of the present invention.

FIGS. 18 and 19 are a processing flow diagram for configuration reception processing of a circuit array module as performed during the power on processing shown in FIG. 13, according to a preferred embodiment of the present invention.

FIG. 20 is a schematic diagram for an exemplary circuit array module for an illustrative application of an exemplary embodiment of the present invention.

FIG. 21 is an equipment layout diagram for an illustrative application of an exemplary embodiment of the present invention.

FIG. 22 is a schematic diagram of a two-circuit array module modular circuit array as used within an illustrative application of an exemplary embodiment of the present invention.

FIG. 23 illustrates a circuit design to module mapping for an illustrative application of an exemplary embodiment of the present invention.

FIG. 24 illustrates a reconfiguration of a two-circuit array module modular circuit array for an illustrative application of an exemplary embodiment of the present invention.

### DETAILED DESCRIPTION OF THE EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

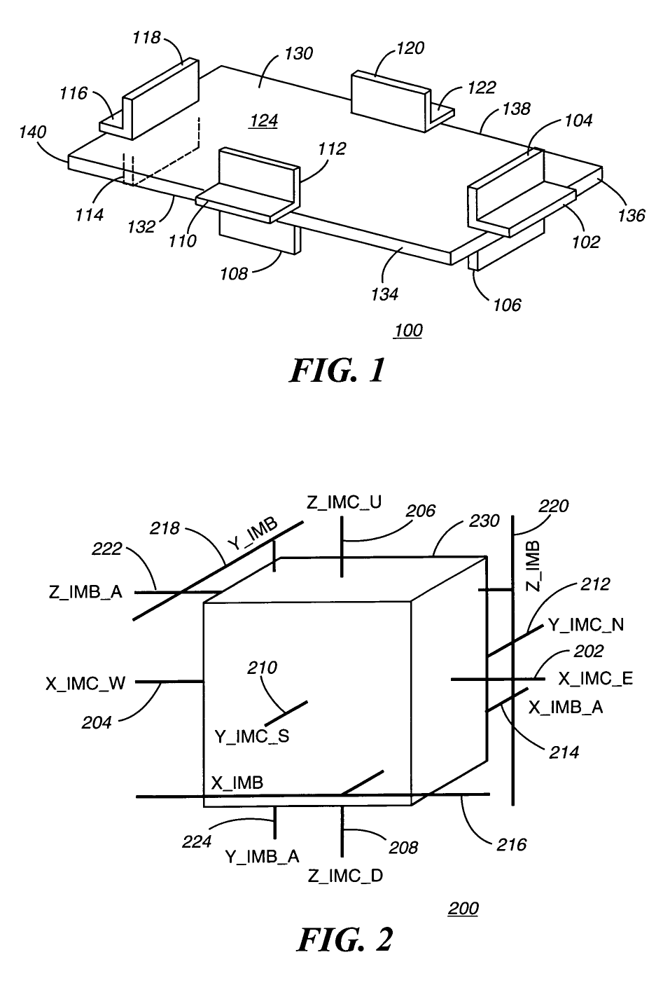

An isometric view of a circuit array module 100 according to an exemplary embodiment of the present invention is illustrated in FIG. 1. The exemplary circuit array module 100 has a module body that includes a circuit board 124 that includes an electronic processor and other electronic circuitry to perform the operations and processing of the exemplary circuit array module 100. The circuit array module 100 is shown to have six surfaces, a top surface 130, a bottom surface 132, and four lateral surfaces, lateral surface A 134, lateral surface B 136, lateral surface C 138 and lateral surface D 140. Each surface of the circuit array module 100 includes at least one connector that is suitable for connecting to a connector on a similar circuit array module that is placed adjacent to this circuit array module and that is to be connected to this circuit array module.

Connectors as used by the various embodiments of the present invention are broadly defined to included connectors that are contained in single or multiple housings, connectors that have a single or multiple signal connection within the one or more housings, connectors that have connections for one or more of electrical, optical, pneumatic, or other signal carrying media. Connectors mounted on a surface are able to include contacts that are formed perpendicular to that surface or at any angle to that surface. Connectors are further able to connect to mating connectors on similar adjacent boards or connectors are also able to connect to cables that are in communication with other processing elements.

In order to facilitate this connection, connectors on opposite surfaces of the exemplary circuit array module 100 are of opposite gender. For example, the first top connector 112, which is mounted on the top surface 130, is a male connector while the first bottom connector 108, which is mounted on the bottom surface, is a female connector. The same relationship is true in the exemplary embodiment for the other top and bottom connectors, i.e., the second top connector 104, the third top connector 120 and the fourth top connector 118 are male gendered while the second bottom connector 106, the third bottom connector (not shown but below the third top connector 120), and the fourth bottom connector 114 are female gendered. The other connectors of the circuit array module 100 similarly have an opposite gender relative to the gender of the corresponding connector on an opposite surface. A corresponding connector in this context refers to the connector to which a particular connector will connect when a similar circuit array module is positioned adjacent to the circuit array module 100 with the same orientation and is to be connected to that particular connector. For example, side connector A 110, which is located on lateral surface A 134, is a male gendered connector and side connector C 122, which is on the opposite lateral surface, lateral surface C 138, is a female connector. Further embodiments of the present invention have different gendered connectors on a single surface, but the corresponding connectors on opposite surfaces of those modules have opposite genders to facilitate mating two or more of these circuit array modules into multiple module arrays. This allows two circuit array modules 100 to be interchangeably mounted one on top of the other.

An interconnection diagram 200 for connections between the circuit array module 100 and adjacent circuit array modules, such as when forming a modular circuit array according to a preferred embodiment of the present invention, is illustrated in FIG. 2. The circuit array module 100 is represented as a cube 230 for ease of understanding. The six sides of cube 230 correspond to the six surfaces of the circuit array module 100, as are discussed above. The circuit array module 100 of the exemplary embodiment interconnects with adjacent circuit array modules through different types of data interconnections. An independent data connection for each of these types of data interconnections extends from the circuit array module 100 in each direction or axis.

The directions of the interconnection diagram 200 are referred to as different axes and denominated herein as X, Y and Z. The X direction runs horizontally to the image of the interconnection diagram, the Y direction conceptually runs into and out of, i.e., perpendicular to, the surface of the interconnection diagram 200, and the Z direction runs vertically. Circuits formed along one of these directions are referred to herein as lying along that axis.

A first type of data interconnection is an Inter-Module Bus (IMB). The IMBs are generally multiple signal line, multiple drop data buses that support parallel connection among circuit array modules that form or connect to that bus. There are three IMBs illustrated in the interconnection diagram 200, one IMB for each direction or axis. There is an X_IMB 216, a Y_IMB 218, and a Z_IMB 220 that correspond to the X, Y and Z axes, respectively. These IMBs allow communications between and among circuit array modules that form or connect to that bus. The IMBs of the exemplary embodiment are formed by connections through the module body of the circuit array module 100. One type of connection that forms the IMBs in the exemplary embodiment has an IMB carried through one connector and routed to and through a connector on an opposite side of the circuit array module 100.

A second type of data interconnection is the Inter-Module Connection (IMC). The IMCs are multiple data line, point-to-point interconnects that allow one circuit array module to communicate with an adjacent circuit array module. Although a circuit array module is able to be configured to support pass-through of one or more signals received on an IMC as required for a particular design, data communication via an IMC is often used to communicate data from one circuit array module to an adjacent circuit array module. Each side or surface of the circuit array module 100 of the exemplary embodiment has a separate IMC, thereby resulting in six IMC data interconnections per circuit array module. Each side or surface of the circuit array module 100 is denoted by a compass point or as being up or down. The designator “W” in the interconnect diagram corresponds to the compass point “West” and refers to the left direction of the diagram. Correspondingly, the “E” corresponds to the compass point “East” and refers to the right direction of the diagram. The “N” corresponds to “North” or the direction into the page and the “S” corresponds to “South” or out of the page. “U” corresponds to “Up” and “D” corresponds to “Down.” The East/West direction is collinear with the X-axis, the North/South direction is collinear with the Y-axis and the Up/Down direction is collinear with the Z-axis. The six IMC data interconnections are illustrated as X_IMC_E 202, X_IMC_W 204, Y_IMC_N 212, Y_IMC_S 210, Z_IMC_U 206, and Z_IMC_D 203. These six data interconnections allow direct, point-to-point data communications between adjacent circuit array modules.

A third type of data interconnection that is present in the exemplary embodiment is the Adjacent IMB, or IMB_A, interconnections. The IMB_A interconnections provide connectivity between a circuit array module and the IMB of the adjacent circuit array module. As an example, the X direction in this interconnection diagram runs in a horizontal direction. Circuit array modules that are adjacent to the illustrated circuit array module and to the left and right of the illustrated circuit array module are connected via the X_IMB 216. Circuit array modules that are adjacent to the illustrated circuit array module and located “behind” the illustrated circuit array module, i.e., along the Y-axis in the “north” direction, are connected to the Y_IMB 218, but not to the X_IMB 216 for the illustrated circuit array module. Circuit array modules located in that direction have another X_IMB data bus that connects circuit array modules in that “row” or X-axis. The X_IMB_A 214, however, is illustrated as exiting the rearward surface of cube 230, and connects to the circuit array module that is located behind the illustrated cube in the “north” direction. The X_IMB_A 214 data interconnection of the exemplary embodiment supports communications between this circuit array module and the X_IMB for the adjacent “X row.” The Y_IMB_A data interconnect 224 is similarly shown as exiting in the downward direction, and the Z_IMB_A data interconnect 222 is shown as exiting in the “West” or “Y” direction.

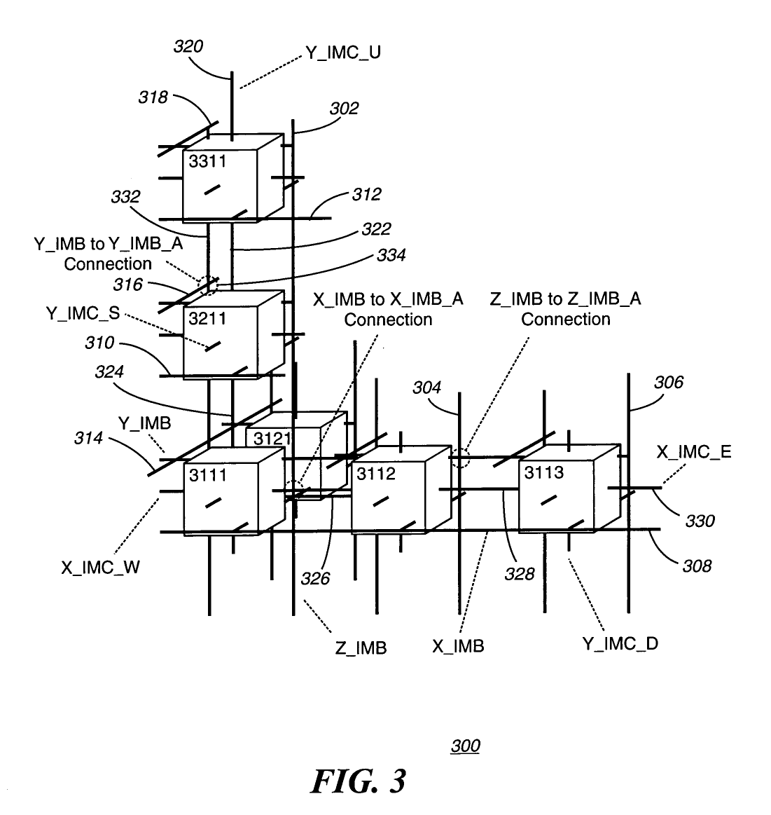

Signal interconnections among a number of circuit array modules that are assembled into a partially populated modular circuit array 300 according to a preferred embodiment of the present invention is illustrated in FIG. 3. This illustration shows the multiple interconnections that are present in a multiple-dimension modular circuit array. A first X_IMB 308 is shown for the lower horizontal line of circuit array modules that consists of module A 3113, module B 3112 and module C 3111. Module D 3211 is shown as located “above” module C 3111. Module D 3211 is connected to a second X_IMB 310, but not directly to the first X_IMB 308. Module D 3200 is further shown as connected to a second Y_IMB 316. Module E 3311, which is located above module D 3211, is also shown as connected to a third Y_IMB 318. A first Y_IMB_A connection 332 is shown as connecting module E 3311 to the second Y_IMB 316 at a Y_IMB to Y_IMB_A connection 334. Module E 3311 is shown as having a data interconnection via a first Z_IMC data interconnection 322, which connects to the Z_IMC_U connection 208 of Module E 3311 and to the Z_IMC_D connection 206 of Module D 3211.

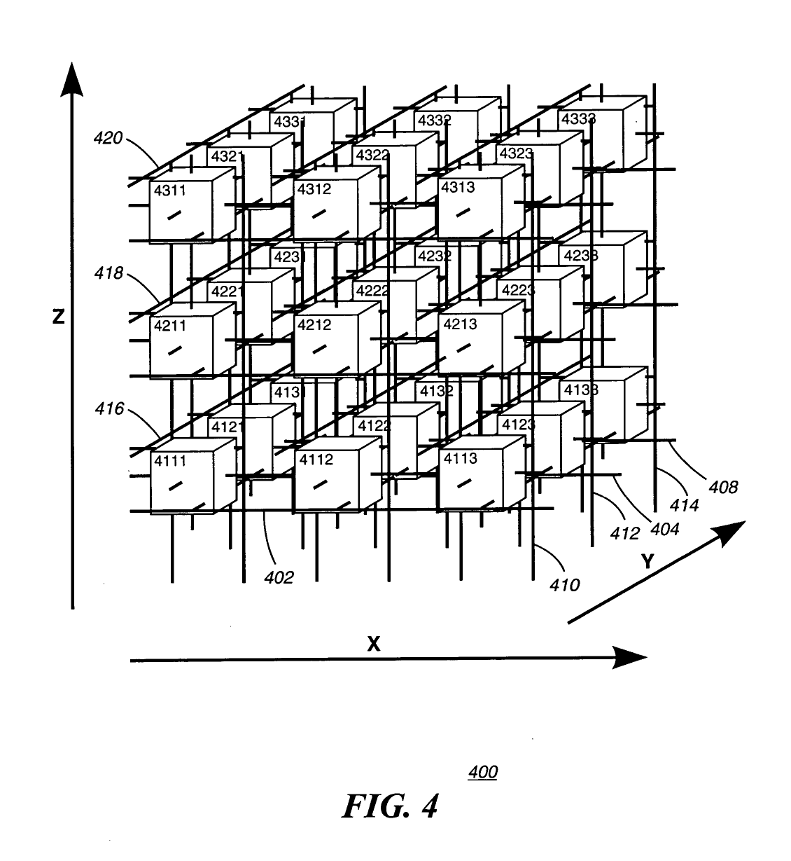

A diagram of signal interconnections among a number of circuit array modules that are assembled into a fully populated three-dimensional cubic modular circuit array 400 according to a preferred embodiment of the present invention is illustrated in FIG. 4. The fully populated three-dimensional cubic modular circuit array 400 is similar to the partial modular circuit array 300 but with a fully configured cube of circuit array modules. A continuous connection of circuit array modules is present in each direction for each row along the entire length of the array. This continuous connection is provided by the multiple IMB interconnections for each row and in each direction or axis.

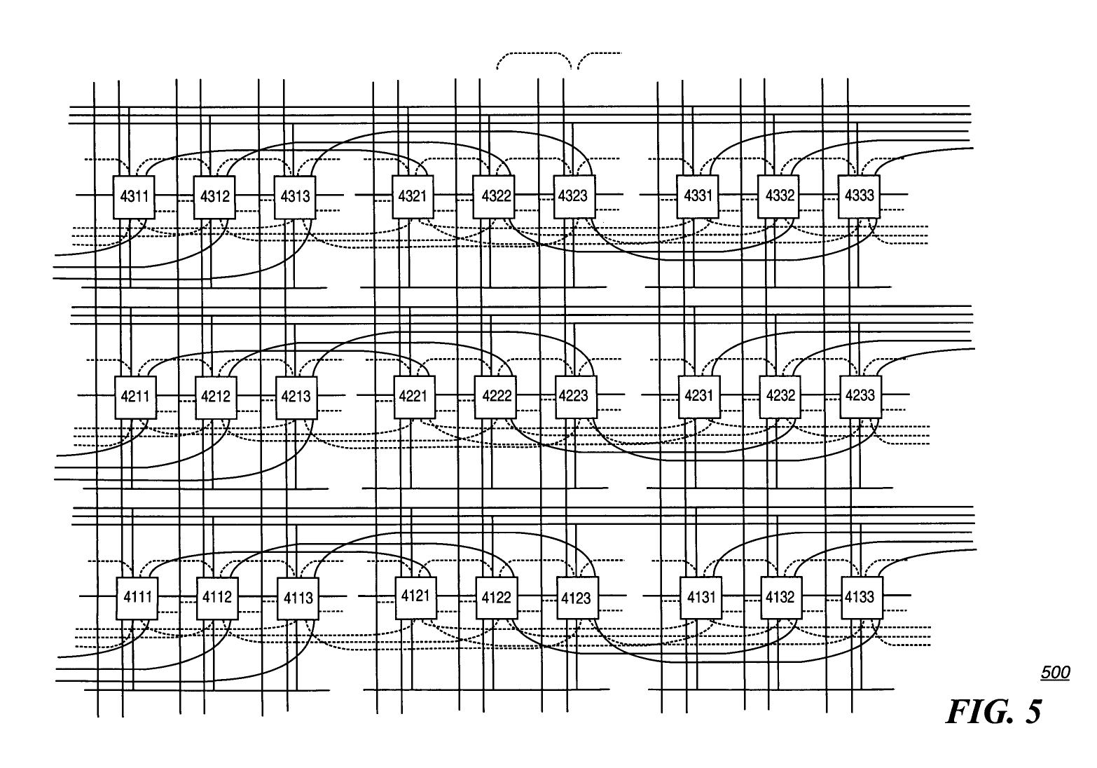

An electrical interconnection diagram 500 of electrical interconnections among a number of circuit array modules that are assembled into a fully populated, three dimensional cube modular circuit array according to a preferred embodiment of the present invention is illustrated in FIG. 5. This electrical interconnection diagram shows the electrical interconnections that are present in the fully populated three-dimensional cube modular circuit array 400.

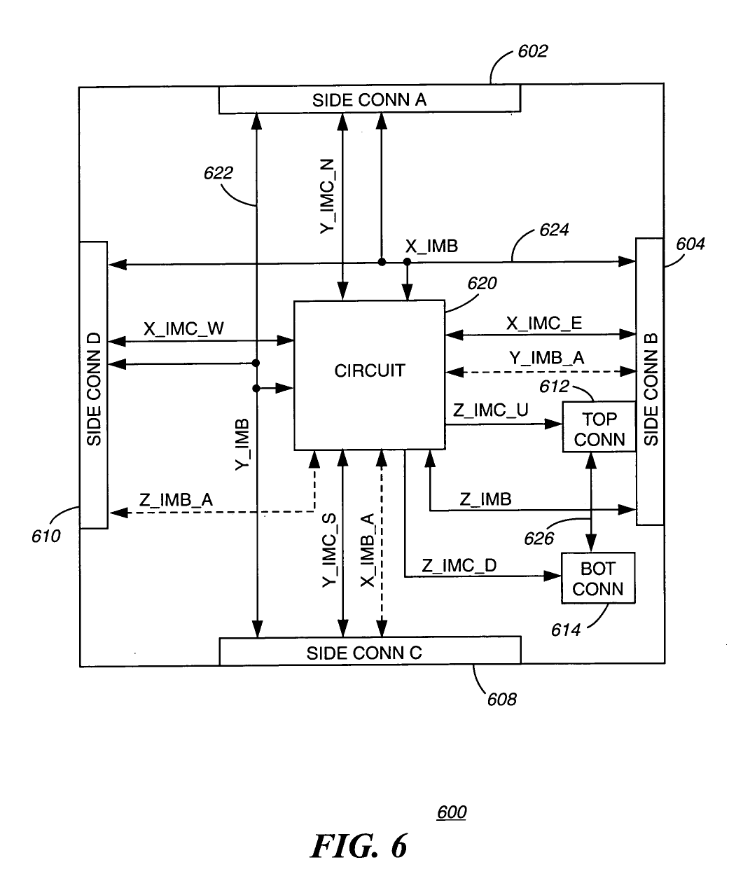

An electrical schematic diagram 600 that illustrates electrical connections within a circuit array module according to a preferred embodiment of the present invention is illustrated in FIG. 6. The circuit array module 600 has a circuit 620 that is connected to the six connectors: side connector A 602, side connector B 604, side connector C 608, side connector D 610, top connector 612 and bottom connector 614, that are present on the circuit array module. This electrical schematic diagram 600 illustrates the connections between circuit 620 and the connectors, which include IMB and IMC data interconnections, as are discussed above. The pass-through of the IMB data interconnects from one connector to a connector located on an opposite side of the module body is illustrated as X_IMB 624 directly connecting side connector B 604 and side connector D 610. Y_IMB 622 similarly connects side connector A 602 and side connector C 608. Z_IMB 626 is also shown to connect top connector 612 to bottom connector 614. The data lines on these buses are also connected to circuit 620.

The circuit 620 of the exemplary embodiment includes one or more of a programmable computer, a microprocessor, a micro-controller, a reduced instruction set computer, a digital signal processor, at least one of a field programmable gate array, an analog to digital converter, a digital to analog converter, a cross-point switch, a memory device, a programmable termination network, user circuit connections, test equipment connections and a wiring interconnect.

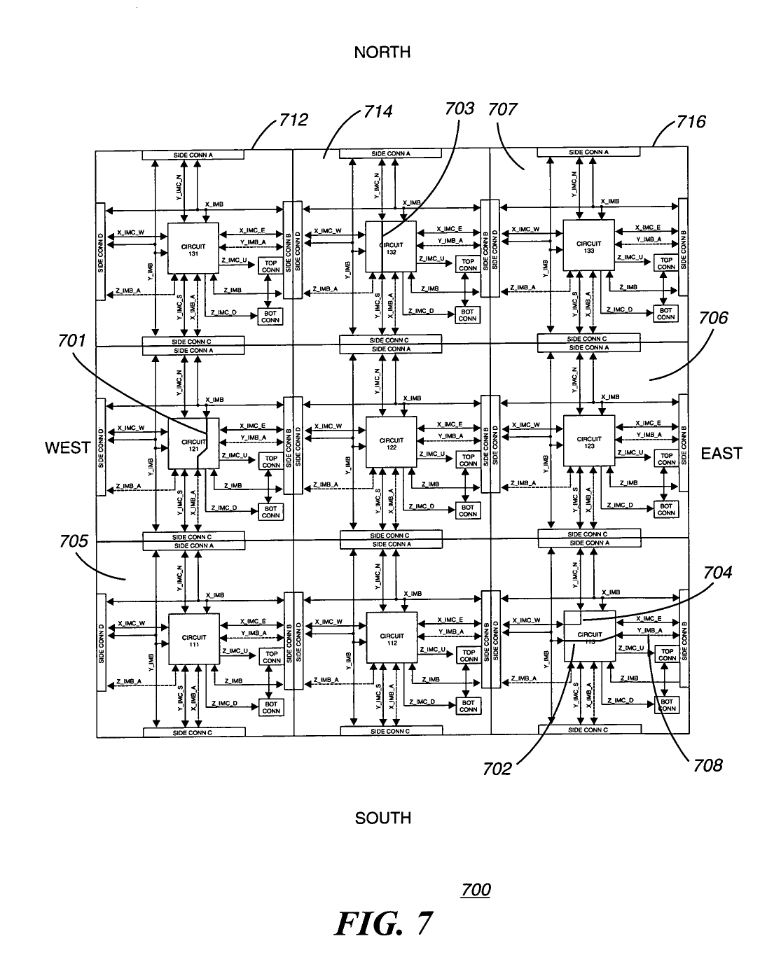

A schematic diagram 700 that illustrates electrical connections and interconnections within and among a number of circuit array modules that are assembled into a fully populated, two dimensional modular circuit array according to a preferred embodiment of the present invention is illustrated in FIG. 7. A circuit array module of the exemplary embodiment is able to route internal signals and common signals, such as bus signals on the IMB and IMC lines, from one module to adjacent circuit array modules. These routings are able to be configured either manually or via an automated routing program. Circuit array modules are also able provide connectivity of signals from any of the circuit array module's connector to any other circuit array module connector. This allows connections on the same axis to be communicated “through” the circuit array module as well as connecting signals that are present on different axes. These signal interconnections include module-to-module interconnections as well as common signal to common signal interconnections, or any combination imaginable.

In addition to simply connecting data lines between connectors, the routing implemented within circuit array modules of the exemplary embodiment also can include inline amplifiers or attenuators. Schematic diagram 700 is an example of the routing performed within a number of circuit array modules that are connected as illustrated in an X by Y 2 dimensional array. Schematic diagram 400 particularly identifies four interconnects that are configured in 3 circuit array modules. The directions, or axes, of this diagram are referred to as “north,” “south,” “east,” and “west,” as are illustrated in the figure.

By connecting the first north X_IMB signal 706, which runs through each circuit array module along the middle row of the X axis, to the first south X_IMB signal 705 by first interconnect 701 in first module 121, a common signal is now available for all circuit array modules in this configuration. That is, the north side of second module 111, third module 112, and fourth module 113 are all connected to the first south X_IMB signal 705, the south side of the first module 121, fifth module 122, and sixth module 123 are also connected to the same first south X_IMB signal 705. To the north side of the first module 121, the fifth module 122, and the sixth module 123 a first north X_IMB signal 706 exists. The south side of a seventh module 131, eighth module 132, and ninth module 133 are also connected to the same first north X_IMB signal 706. The common signals also available are at the external east and west boundaries of the second module 111, first module 121, fourth module 113, and sixth module 123.

The first west Y_IMB signal 707 in this example is connected to the first east Y_IMB_A signal 708 by second interconnect 702 in fourth module 113 in order to provide an external common signal that exists to the east of fourth module 113 for connection to the third module 112, fourth module 113, fifth module 122, sixth module 123, eighth module 132, ninth module 133, and the north connection in the ninth module 133. Referring to a third interconnect 703, the Y_IMC_N connection of fifth module 122 is routed through eighth module 132 and brought to the Y_IMC_S connection of the eighth module 132. Referring to a fourth interconnect 704, the X_IMC_E signal of third Module 112 is connected to the Y_IMC_S signal of sixth module 123.

The circuit array modules of the exemplary embodiment communicate data across various data interfaces that are conveyed over connectors on the surfaces of the circuit array module, such as the first top connector 112. These interfaces include a Configuration Interconnect (CI), a Data Interconnect (DI), and a Power Supply Interconnect (PSI) interface.

The Configuration Interconnect (CI) of the exemplary embodiment is connected to all circuit array modules and is used to allow an external computing device, such as a personal computer, workstation, or other microprocessor based system, to be used to configure and query the status of one or more circuit array modules in the modular circuit array. The CI is also used for module-to-module communications to identify the configuration and query the status of circuit array modules in order to support a determination of which configuration file a particular module is to load. The CI is able to contain a serial and/or parallel and/or optical buses. For example, in some cases a circuit array module may contain a circuit that requires programming by way of the Joint Test Action Group (JTAG) standard. In such a situation, the serial JTAG protocol data bus is provided to that circuit array module. In a second example, the CI may use an address and data bus to send and retrieve information from one or more circuit array modules. This type of data interface allows for rapid configuration of the circuit array modules in the system.

To relieve the complexity of routing the JTAG interface signals, especially where some circuit array modules may not have interconnections or support JTAG signals, some embodiments send address and data to a circuit array module via a parallel interface that then routes the JTAG signals to that device. In this case, more than one interface is present and active.

In addition to configuring the circuit array modules, the CI of the exemplary embodiment is also used to scan each circuit array module and to determine circuit array module parameters including, but not limited to: a) the circuit array module identification; b) the circuit array module location; c) onboard memory sizes and types; d) the performance parameters of the devices on the circuit array module; and e) the circuit array module serial number.

It is sometimes desirable to separate routing of the CI to different circuit array modules within the array. This is accomplished in the exemplary embodiment by manual or programmable interconnect or by specific circuit array modules that provide this feature. An example application that benefits from separate CI buses is a multi-user environment where two or more engineers are integrating each of their designs into a common modular array. In this application, each engineer is able to modify their design and download it into their specific circuit array modules in the modular array.

The Data Interconnect (DI) connections are used by an external computing device, such as a personal computer or workstation, to provide high-speed data to and from the modular array. For example, high-speed stimulus and response data may be transferred to a test module embedded in the array, or a memory dump of a microprocessor program area may be extracted and evaluated in the workstation. An additional example includes porting of a continuous capture of circuit operations data through the DI to a data capture device for post processing of the data.

In some applications the DI is to be separated within the array. This is accomplished in some embodiments by manual or programmable interconnections or by specific circuit array modules that provide this feature. As above, an example application where the DI is to be separated is in a multi-user environment where two or more engineers are integrating each of their designs into a common modular array. In such an application, each engineer is able to capture or stimulate their part of the design in their specific circuit array modules in the array.

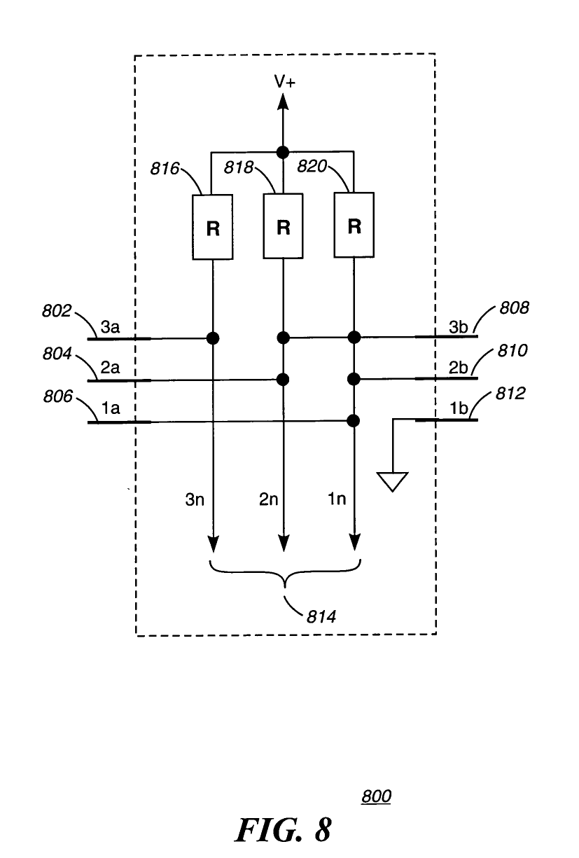

A schematic diagram of an exemplary single dimension module location determination circuit 800 for determining a single axis location within an array, according to an exemplary embodiment of the present invention, is illustrated in FIG. 8. The exemplary single dimension module location determination circuit 800 is used to allow an individual circuit array module to determine its position within a modular circuit array. The exemplary module location determination circuit 800 is representative of module location circuits that are included into each of the exemplary circuit array modules 100 and provides an indication of the location, within a modular circuit array, of the circuit array module in one dimension. The exemplary module location circuit can be used in any application where interconnected components are to determine their location relative to each other. A description of the module location determination circuit that is incorporated into the exemplary embodiment of the present invention is provided below.

The exemplary single dimension module location determination circuit 800 is a passive circuit that provides a three digital line location output 814 that is able to encode a location relative to other circuit array modules that are connected to the circuit array module with the exemplary single dimension module location determination circuit 800. The location output 814 of the exemplary single dimension module location determination circuit 800 is able to provide an encoded location value for one more location than the number of digital lines in the location output 814, as is described below.

The exemplary single dimension module location determination circuit 800 has three incoming location data lines that consist of an incoming location data line 1a 806, an incoming location data line 2a 804 and an incoming location data line 3a 802. These three incoming location data lines form an ordered set of digital data lines to identify circuits. The digital value represented on these lines is provided as the location output 814. Each of these three incoming position data lines are connected to a positive digital voltage through a pull-up resistor, such as the first resistor 816, second resistor 818 and third resistor 820.

The exemplary single dimension module location determination circuit 800 has a set of output location data lines, which consist of output location data line 1b 812, output location data line 2b 810 and output location data line 3b 808. These output location data lines are configured so as to produce encoded information that automatically identifies the location of the “downstream” circuit array module. In the exemplary embodiment, first output location data line, output location data line 1b 812 is connected to a circuit ground connection. The second output location data line, output location data line 2b 810, is connected to the first incoming location data line 1b 806. The third output location data line, output location data line 3b 808, is connected to the second incoming location data line, incoming location data line 2b 804. This results in a unique location data output being provided in the direction or axis for this circuit array module and module location determination circuit 800. Due to the passive component design of the single dimension module location determination circuit 800, the input lines and the output lines are able to receive and produce output signals. As is described below, the processing of the exemplary embodiments allows module location data to be received at the output location data lines.

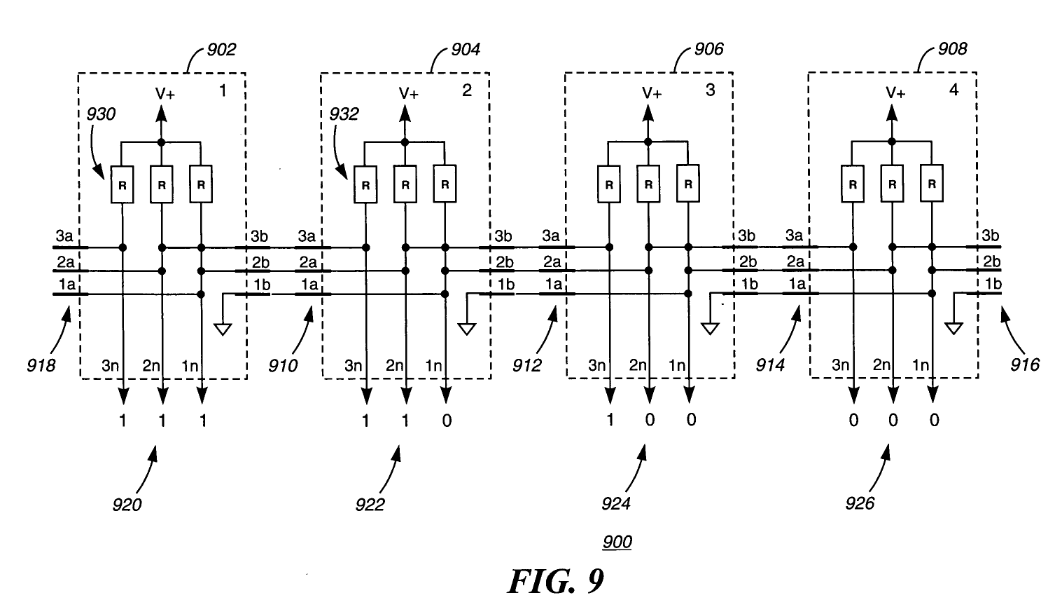

A schematic diagram that illustrates an exemplary cascade of module location determination circuits 900 in one dimension according to an exemplary embodiment of the present invention is illustrated in FIG. 9. The exemplary cascade of module location determination circuits 900 shows four single axis module location determination circuits 800, one of each is part of one of four circuit array modules 100 that are connected in series along one axis or direction. The first circuit array module has a first single axis location determination circuit 902. The first incoming location data input 918 of the first circuit array module is unconnected to another circuit, so the first location data output 920 is set to all high data values due to the first set of pull-up resistors 930. The first output location data is transmitted through a first location data interface 910 to a second single axis module location determination circuit 904. The first output location data line 1b is set to a low logic data value because that line is connected to circuit ground. The other output location data lines have a high logic value because they are connected to the first and second location data lines, as is discussed above.

The second module location data 922 in this example is set to “110.” This corresponds to the value received at the incoming location data interface 910. The output location data is produced at the second location data interface 912 to a third single axis module location determination circuit 906. The output location data 912 produced by the second location determination circuit 904 has a logic low value on the first and second line, and a high logic value on the third line, as is shown in the illustration. This results in the location data for the third location determination circuit 906, which is part of a third circuit array module, having a value of “100.” The schematic diagram of the exemplary cascade of module location determination circuits 900 shows that the fourth module location circuit 908 produces a location data value of “000.” Thus, the cascaded single axis location determination circuits of the exemplary embodiments produce an ordered location data of “111,” “110,” “100,” “and “000” to allow unique and automatic identification of the location of four cascaded circuit array modules without explicit configuration of each circuit. Processing with the circuit array module 100 is able to properly map, process or translate these values as necessary to properly use this data for circuit array module configuration, operation or any other uses of a particular design.

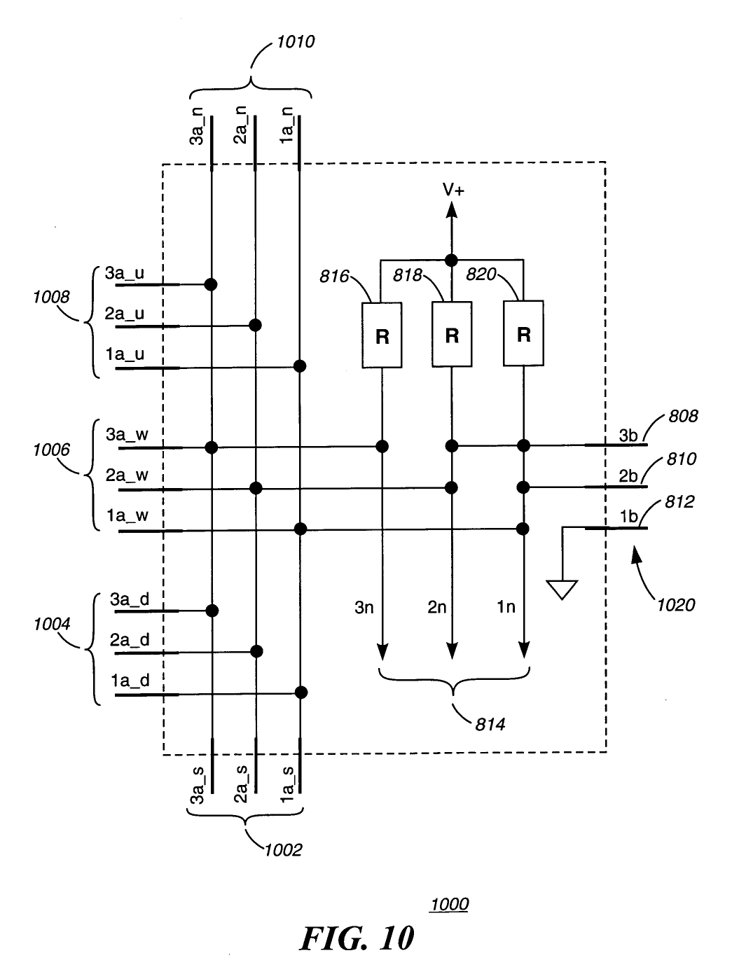

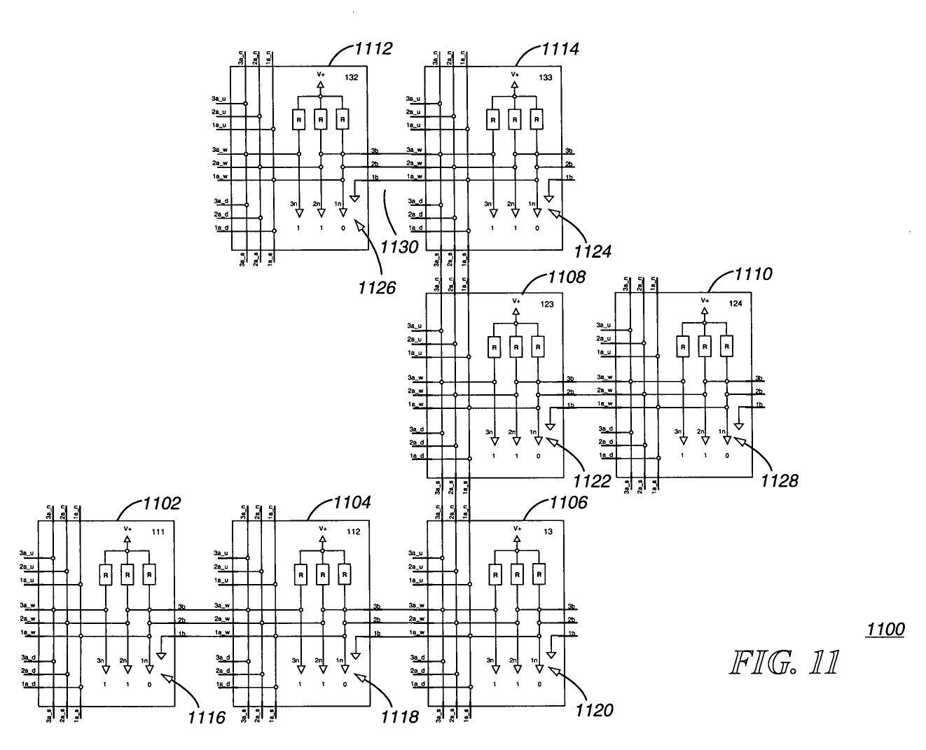

A schematic diagram of an exemplary five input module location determination circuit 1000 for use in a circuit array module supporting connections to adjacent circuit array modules in three dimensions, as is used in a preferred embodiment of the present invention, is illustrated in FIG. 10. The exemplary five input module location determination circuit 1000 is used to produce location determination information in one axis for a circuit array module 100 that is designed to connect with six adjacent circuit array modules in order to form a three dimensional modular circuit array 400. The exemplary five input module location determination circuit 1000 has pull-up resistors, including first pull-up resistor 816, second pull-up resistor 818, and third pull-up resistor 820, as is shown for the single dimension module location determination circuit 800. The exemplary five input module location determination circuit 1000 also has similar output location data lines with an output location data line 1b 812, output location data line 2b 810, and output location data line 3b 808. The incoming location data lines, however, are shown to incorporate five parallel sets of three incoming data lines. These five parallel sets are connected to connectors that are on five of the six sides of the circuit array module 100, i.e., each of these five inputs come from a different direction in the three dimensional array. The inputs ending in “u” are from the “up” direction, inputs ending in “d” are from the “down” direction, inputs ending in “w” are from the “west” direction, inputs ending in “N” are from the “north” direction, and inputs ending in “s” are from the “south” direction. An incoming location data connector is not provided on the “downstream” side of the circuit array module, which is the side that corresponds, and that connects to, the circuit array module that is in the next highest location in the dimension for this location determination circuit 1000. In this example, the “e” or “east” direction is the direction that is downstream and from which no incoming location data is received. The circuit array module from which no incoming location data is received is the only circuit array module in this example to which the output location data 1020 is provided.

A schematic diagram of interconnected single dimension module location determination circuits 1100 located on a number of circuit array modules that are able to form a partially populated three dimension modular circuit array, according to a preferred embodiment of the present invention, is illustrated in FIG. 11. The location determination circuits illustrated in this example provide location data in one dimension and are shown for a number of circuit array modules that are arranged in partially populated a two dimensional array. These circuits are replicated three times in the exemplary embodiment, once for each dimension, in order to support construction of three dimensional modular circuit arrays. In this example, three circuit array modules in the bottom row of circuit array modules, i.e., the first module 1102, second module 1104 and third module 1106, are connected in series and have location data that reflect the first three locations along that dimension. The first module 1102 has a first location data 1116 that is equal to “111.” The second module 1104 has a first location data 1118 that is equal to “110.” The first module 1106 has a first location data 1120 that is equal to “100.” A fourth module 1108 is located “above” the third module 1106 and therefore has the same location value in the horizontal dimension. This is reflected by the fourth location data 1122 of “100.” The design of the five input single dimension location determination circuit 1000 provides this result because the five inputs are all in parallel. The same is true for the fifth module 1114, which is above the fourth module 1108 and therefore has the same location data with the fifth location data 1124 set to “100.” The sixth module 1110 is “downstream” from the fourth module 1108, and therefore is in the fourth horizontal position and has a sixth location data 1128 of “100.”

A unique feature of the single dimension location determination circuit is that data can be received on the output location data lines and used to produce correct location data even when no incoming location data is present. The location “input” lines can similarly provide an output of location signal data. The exemplary interconnected single dimension module location determination circuits 1100 shows a seventh module 1112 that is only connected to the fifth module 1114 through an location data interconnection 1130. This location data interconnection is connected to the output location data lines of the seventh module 1112, but the design of the single dimension location determination circuit, which uses only circuit routing and pull-up resistors, ensures that the proper location data is available at the seventh location data 1125, which reflects the second horizontal position in the exemplary embodiment. This connection further has the data provided to the seventh module 1112 through the location data “input” lines of the fifth module 1114. This proper location data is produced even though no other “input” location data is present, and only part of the modular circuit array is populated.

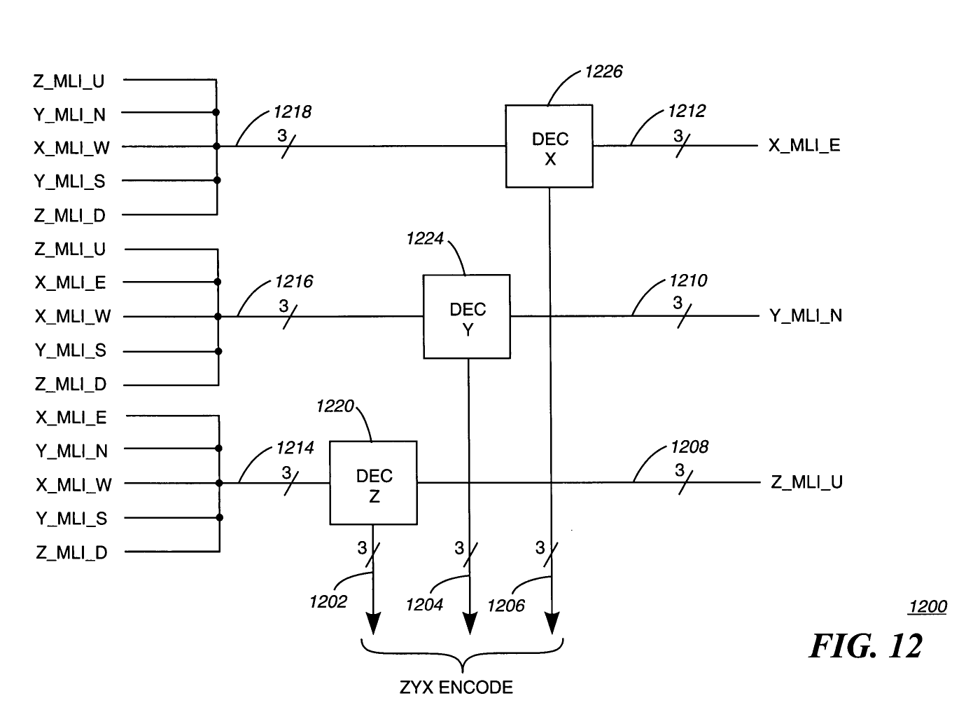

A schematic diagram for a three dimensional module location determination circuit 1200 as is incorporated into a circuit array module supporting connections to adjacent circuit array modules in three dimensions, according to a preferred embodiment of the present invention, is illustrated in FIG. 12. The three-dimensional module location determination circuit 1200 has three each five input single dimension location determination circuits, one for each dimension. These three location determination circuits include an X dimension location determination circuit 1126, a Y dimension location determination circuit 1124, and a Z dimension location determination circuit 1120. The X dimension location determination circuit 1226 has five inputs for incoming location data 1218 to be received or provided to five adjacent circuit array modules, as is described above. The X dimension location determination circuit 1225 produces an X dimension location data 1206 and an X dimension output location data 1212, as is described above. The Y dimension and Z dimension location determination circuits are similarly designed, but connected to adjacent circuit array modules to produce location data for those circuit array modules in their respective dimensions.

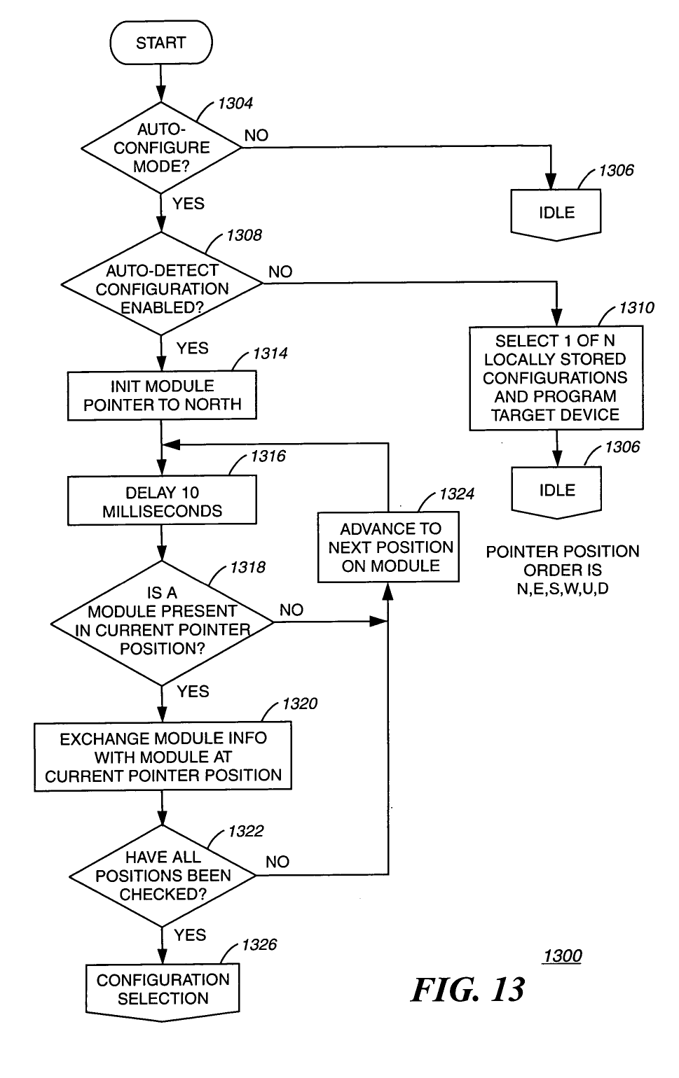

A power on reset processing flow diagram 1300 for of a circuit array module, according to a preferred embodiment of the present invention, is illustrated in FIG. 13. The power on reset processing in this embodiment is performed when a circuit array module is powered on or when a power on reset is initiated by processing with the circuit array module or in response to a command received by the circuit array module. The power on reset processing in the exemplary embodiment begins by determining, at step 1304, if the circuit array module is in an auto-configure mode. If the circuit array module is not in an auto-configure mode, the processing advances to idle processing, at step 1306, as is described below.

If the circuit array module is in auto-configure mode, the processing advances to determining, at step 1308, if auto-detect configuring for that circuit array module is enabled. If auto-detect configuring is not enabled, the processing advances to idle processing, at step 1306, as is described below.

If auto-detect configuring is determined to be enabled, the processing advances to initializing, at step 1314, a module pointer to point to the adjacent circuit array module that is connected to this circuit array module in the “north” direction. The processing of the exemplary embodiment maintains a pointer that indicates with which adjacent circuit array module the processing will communicate and exchange command and data. After initializing the circuit array module pointer in the “north” direction, the processing of the exemplary embodiment then proceeds to delay, at step 1316, for example ten milliseconds. After this delay, the processing determines, at step 1318, if a circuit array module is present at the location indicated by the current pointer position. If no circuit array module is located in the location indicted by the current pointer position, the processing advances, at step 1324, the module pointer to the next adjacent circuit array module connection location. The processing then delays, at step 1316, for ten milliseconds and continues as described above.

If it is determined that there is a circuit array module present in the current pointer position, the processing then advances to exchange, at step 1320, circuit array module information with the circuit array module in the location indicted by the current module pointer. Information exchanged in this step includes, for example, the type of circuit array module in that location, the configurations of the circuit array module in that location and other information, including information that is relevant to proper configuration of circuit array modules within a modular circuit array.

After exchange of information with the circuit array module indicated by the module pointer, the processing continues by determining, at step 1322, if all positions of adjacent circuit array module locations have been checked. If all positions have not been checked, the processing advances, at step 1324, the module pointer to the next position and continues processing as described above. If all positions have been checked, the processing advances to configuration selection processing, at step 1326.

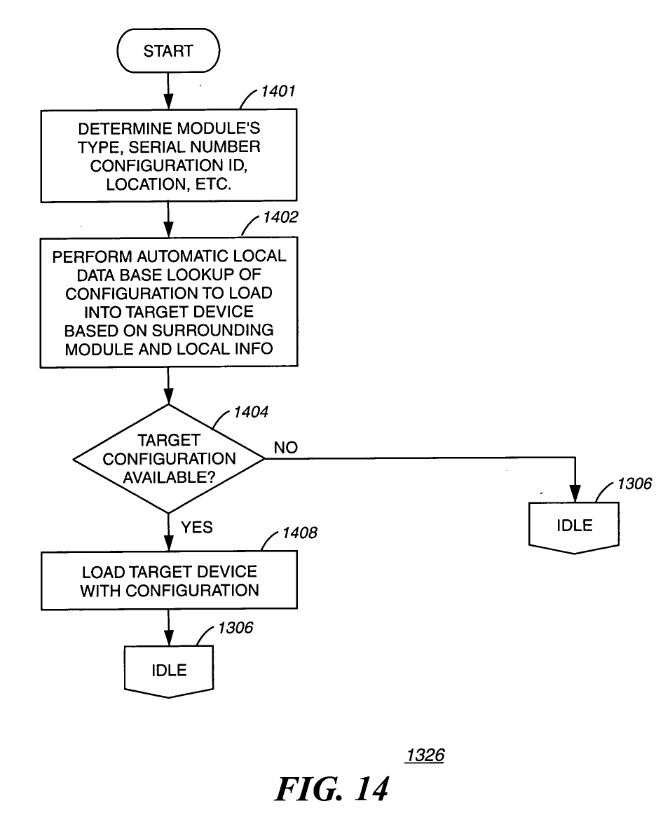

A processing flow diagram for configuration selection processing 1326 of a circuit array module, according to a preferred embodiment of the present invention, is illustrated in FIG. 14. The configuration selection processing 1326 of the exemplary embodiment begins by determining, at step 1401, data for this circuit array module. Information to be determined includes, for example, the circuit array module type, circuit array module serial number, circuit array module configuration identification, circuit array module location, and other circuit array module information. Module location in the exemplary embodiment is determined through the location determination circuits described herein. The processing next performs, at step 1402, automatic local data base lookup of a configuration to load into this target device based upon information derived from surrounding modules and from this circuit array module's local information, as was determined in step 1401. The exemplary embodiment of the present invention stores a number of configurations in a database within the circuit array modules. The processing of this step selects and looks up one of those configurations to load into this circuit array module based upon these criteria.

The processing then determines, at step 1404, if a target configuration, which is the configuration selected by the above processing, is available. If the selected target configuration is not available, the processing advances to idle processing, at step 1306, as is described below.

If the target configuration is determined to be available, the processing of the exemplary embodiment loads, at step 1408, this circuit array module, which is the target device in this context, with the selected configuration. The processing then advances to idle processing, at step 1306.

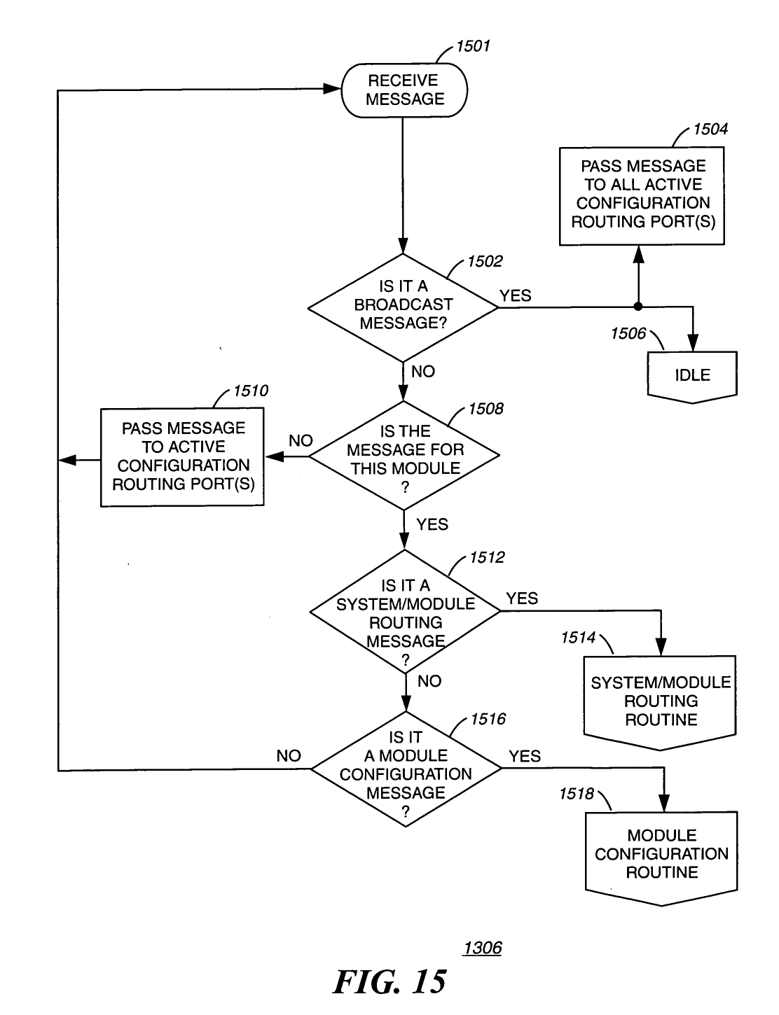

An idle processing 1306 flow diagram of a circuit array module, according to a preferred embodiment of the present invention, is illustrated in FIG. 15. The idle processing 1306 begins by receiving, at step 1501, a message via a data connection to the circuit array module. The processing next determines, at step 1502, if the message is a broadcast message. If the message is a broadcast message, the processing passes, at step 1504, the message to all active configuration routing ports connected to adjacent circuit array modules in order to communicate this broadcast message to all of the circuit array modules in the modular circuit array. The processing also executes a broadcast receive routine, at step 1506, as is further described below. The processing then returns to receiving, at step 1501, a message.

If the message was not a broadcast message, the processing advances to determine, at step 1508, if the message is to be processed by this circuit array module. If this message is not to be processed by this circuit array module, the processing passes, at step 1510, the message to active configuration routing ports so as to distribute the message to adjacent circuit array modules.

If this message is determined to be processed by this circuit array module, the processing determines, at step 1512, if the message is a system/module routing message. If the message is determined to be a system/module routing message, the processing performs a system/module routing routine, at step 1514. If the message is not determined to be a system/module routing message, the processing advances to determining, at step 1516, if the message is a module configuration message. If the message is determined to be a module configuration message, the processing performs a module configuration routine 1518. If the message was not determined to be a module configuration message, the processing returns to receiving a message, at step 1501.

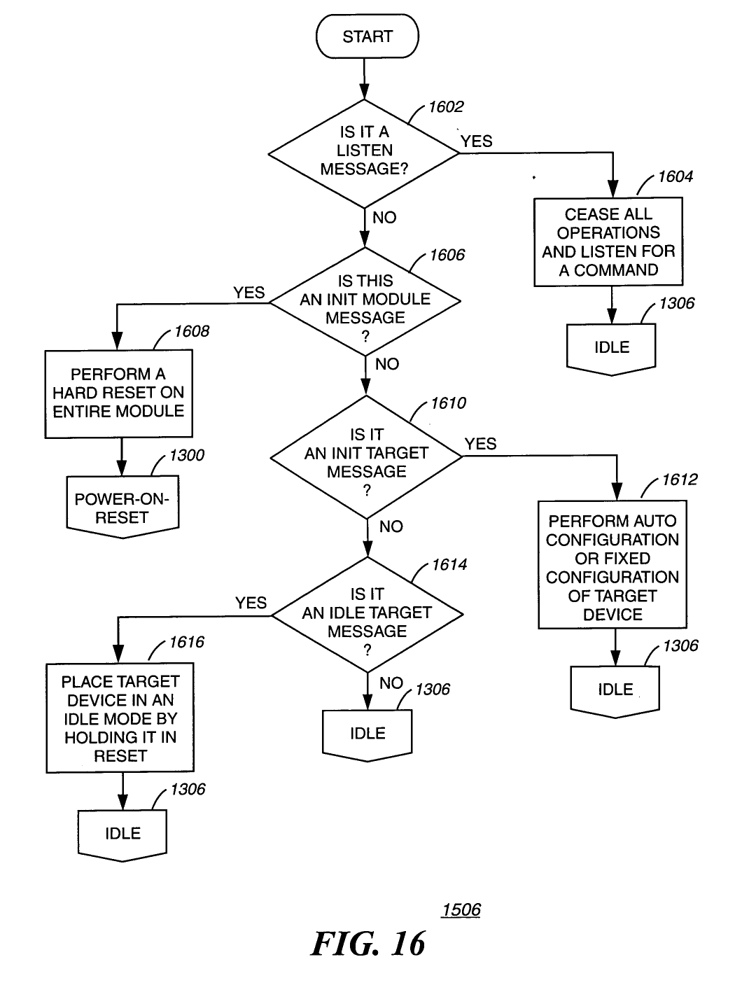

A broadcast message receive routine processing 1506 flow diagram of a circuit array module, according to a preferred embodiment of the present invention is illustrated in FIG. 16. The broadcast message receive routine processing 1506 processes broadcast messages as determined and produced by the idle processing 1306. The broadcast begins by determining, at step 1602, if the message was a listen message. If the message was determined to be a listen message, the processing ceases, at step 1604, all operations and listens for a command. The processing then returns to idle processing at step 1306.

If the message was not determined to be a listen message, the processing determines if the message is an initialize module message. If the message is determined to be an initialize module message, the processing performs, at step 1608, a hard reset of the circuit array module. The processing then returns to the power on reset processing, at step 1300.

If the message was not determined to be an initialize module message, the processing next determines, at step 1610, if the message was an initialize target message. If the message was an initialize target message, the processing performs, at step 1612, auto configuration or fixed configuration of the target device. Auto configuration in this context refers to the selection of a configuration based upon determined data, such as data describing the target module, neighboring modules, and the like. Manual configuration is a process whereby the array design defines the configuration for that module, which is able to be specified in the received message or defined elsewhere. The processing of the exemplary embodiment then returns to idle processing, at step 1306.

If the received message was determined to not be an initialize target message, the processing advances to determine, at step 1614, if the message was an idle target message. If the message was determined to be an idle target message, the processing advances by placing, at step 1616, the target device in an idle mode by holding the target circuit array module circuitry in a reset state. The processing then performs the idle processing, at step 1306. If the message was not determined to be an idle target message, the processing returns to idle processing, at step 1306.

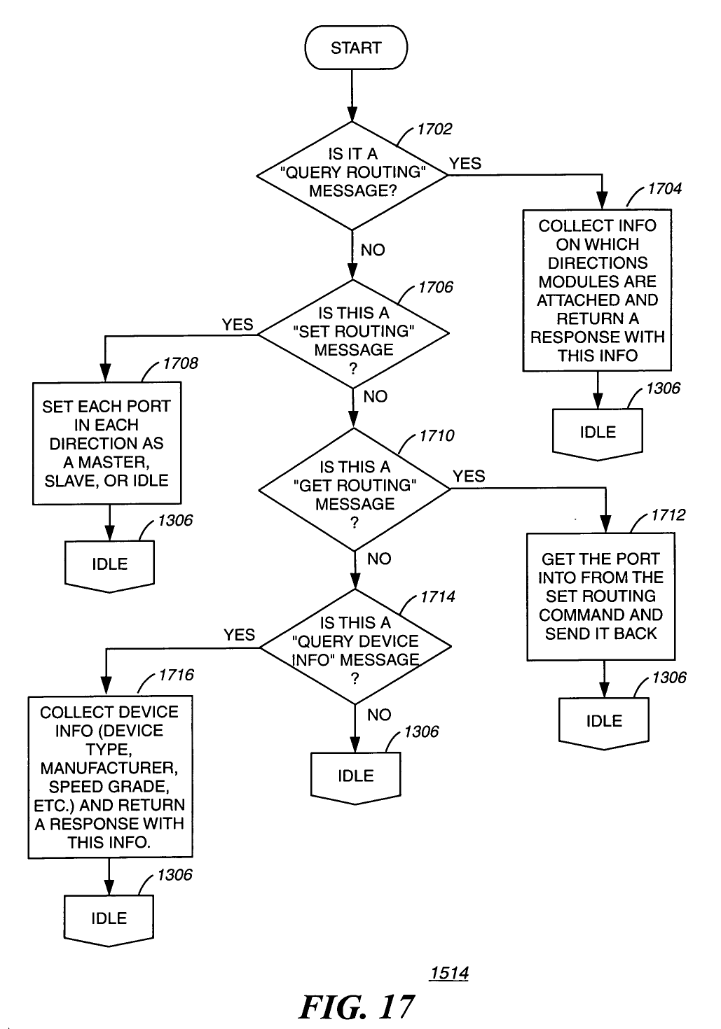

A received message routing processing 1514 flow diagram for a circuit array module, according to a preferred embodiment of the present invention, is illustrated in FIG. 17. The receive message routing 1514 is performed as part of the idle processing 1306 and receives a message that was determined to be a routing message. The receive message routing processing 1514 begins by determining, at step 1702, if the message is a query routing message. If the message is determined to be a query routing message, the processing collects, at step 1704, information describing in which directions circuit array modules are attached to this circuit array module and returns a response to the query with this determined information. The processing then performs idle processing, at step 1306.

If the message is not determined to be a query routing message, the processing of the exemplary embodiment then determines, at step 1706, if this is a set routing message. If the message is determined to be a set routing message, the processing sets, at step 1708, each port in each direction as a master, slave or idle communications port, as is specified by the message. The processing then performs idle processing, at step 1306.

If the message was not determined to be a set routing message, the processing next determines, at step 1710, if the message is a get routing message. If the message is a get routing message, the processing of the exemplary embodiment gets, at step 1712, the port information from the set routing command and returns this information. The processing then returns to the idle processing, at step 1306.

If the message was not determined to have been a get routing message, the processing determines, at step 1714, if the message was a query device information message. If the message was determined to have been a query device information message, the processing collects, at step 1706, device information that includes, for example, device type, manufacturer, speed grade of the device, and other information, and returns this collected information in a response. The processing then returns to idle processing at step 1306. If the message was not determined to have been a query device information message, the processing returns to idle processing, at step 1306.

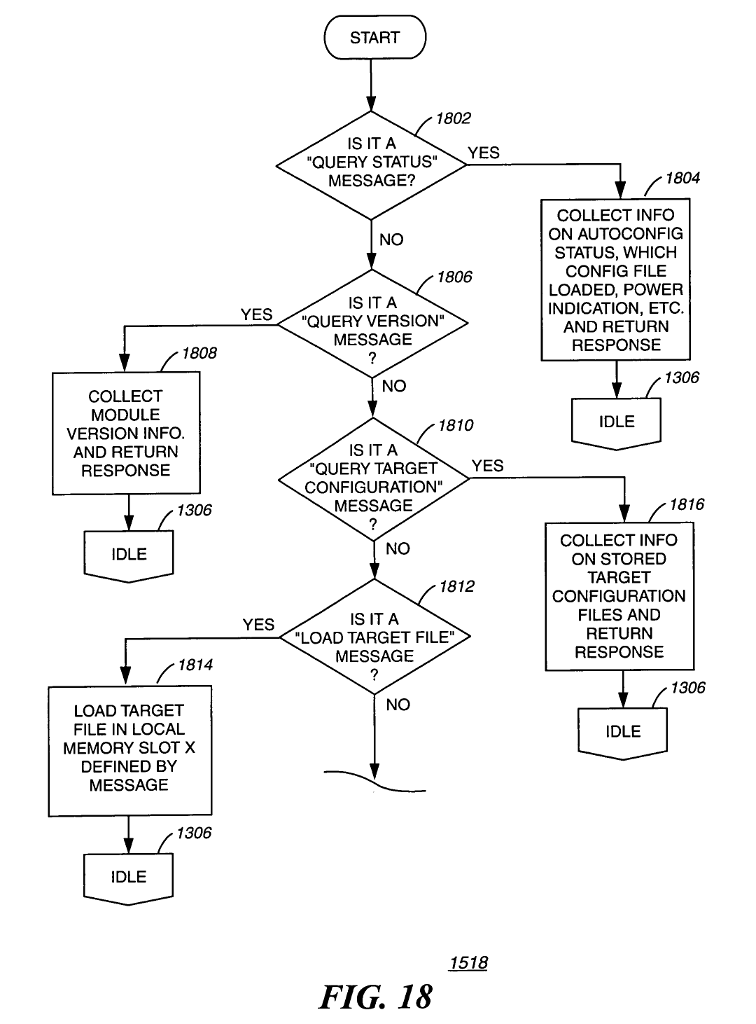

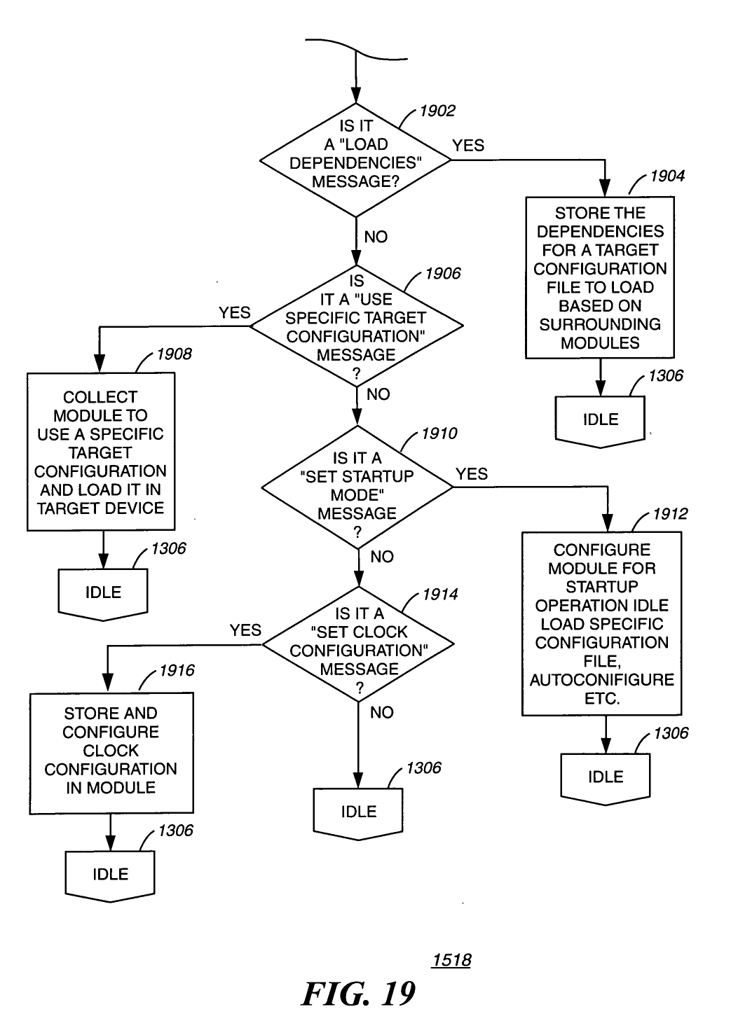

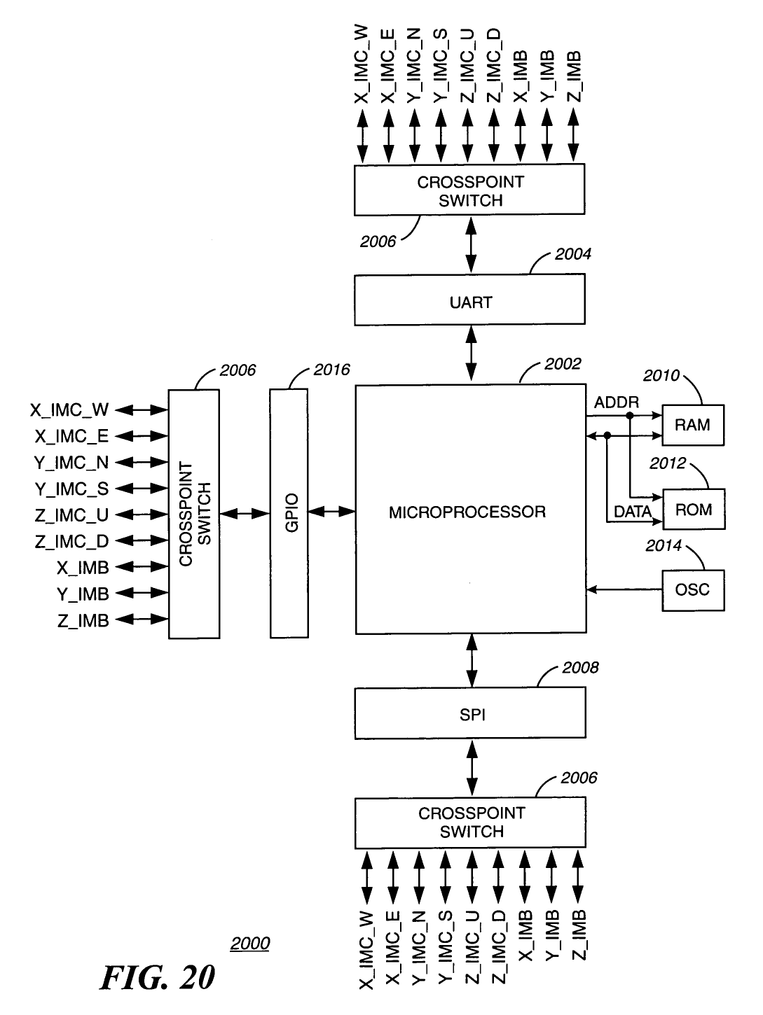

A module configuration reception processing 1518 flow diagram for a circuit array module, according to a preferred embodiment of the present invention, is illustrated in FIGS. 18 and 19. The module configuration reception processing is performed as part of the idle routine 1306 and receives a message that was identified as a module configuration message. The module configuration reception processing begins by determining, at step 1802, if the message was a query status message. If the message was determined to have been a query status message, the processing collects, at step 1804, information such as auto-configuration status, which configuration file is loaded in the circuit array module, indications of power to the circuit array module and other information. This collected information is then returns in a response message. The processing then returns to idle processing at step 1306. If the message was not determined to have been a query status information message, the processing next determines, at step 1806, if the message is a query version message. If the message is a query version message, the processing of the exemplary embodiment collects, at step 1808, the circuit array module version information for this circuit array module and returns this information in a message. The processing then returns to the idle processing, at step 1306.

If the message was not determined to have been a query version message, the processing next determines, at step 1810, if the message is a query target configuration message. If the message is a query target configuration message, the processing of the exemplary embodiment collects, at step 1816, information on started target configuration files and returns this information in a response. The processing then returns to the idle processing, at step 1306.

If the message was not determined to have been a query target configuration message, the processing next determines, at step 1812, if the message is a load target file message. If the message is a load target file message, the processing of the exemplary embodiment loads, at step 1814, target file in the local memory slot as defined by the message. The processing then returns to the idle processing, at step 1306.

If the message was not determined to have been a load target file message, the processing flow diagram continues to FIG. 19 and the processing next determines, at step 1902, if the message is a load dependencies message. If the message is a load dependencies message, the processing of the exemplary embodiment stores, at step 1904, the dependencies that have to be satisfied in order to load a particular target configuration file. Examples of dependencies include pre-conditions for surrounding circuit array modules. The processing then returns to the idle processing, at step 1306.

If the message was not determined to have been a load dependencies message, the processing then determines, at step 1906, if the message is a use specific target configuration message. If the message is a use specific target configuration message, the processing of the exemplary embodiment configures, at step 1908, the circuit array module with the specified target configuration and loads that configuration into the circuit array module. The processing then returns to the idle processing, at step 1306.

If the message was not determined to have been a use specific target configuration message, the processing then determines, at step 1910, if the message is a set startup mode message. If the message is a set startup mode message, the processing of the exemplary embodiment configures, at step 1908, the circuit array module for start operation idle, loads a specific configuration file, auto configures the circuit array module, and so forth. The processing then returns to the idle processing, at step 1306.

If the message was not determined to have been a set startup mode message, the processing then determines, at step 1914, if the message is a set clock configuration message. If the message is a set clock configuration message, the processing of the exemplary embodiment stores and configures, at step 1916, the clock configuration in the circuit array module. The processing then returns to the idle processing, at step 1306. If the message was not determined to have been a set clock configuration message, the processing then returns to the idle processing, at step 1306.

Exemplary Application

Circuit array modules of the exemplary embodiment are able to be used in a variety of applications. An exemplary application is the test and evaluation of digital signal processing circuits. An exemplary microprocessor circuit array module 2000 for use in such an application is illustrated in FIG. 2000. The exemplary microprocessor circuit array module 2000 has a microprocessor 2002 with associated RAM 2010, ROM 2012 and an oscillator 2014. The circuitry of the microprocessor circuit array module 2000 has electrical interfaces to adjacent circuit array modules via the IMC and IMB buses as are described above. The IMC and IMB buses are connected to the specific processing circuit of the microprocessor circuit array module via cross point switches 2006. A number of interfaces between the microprocessor 2002 and the external data interconnects are possible. Shown in this example are a Universal Asynchronous Receive and Transmit (UART) circuit 2004 for general serial data interfaces, a Serial Peripheral Interface (SPI) circuit 2008 for more specialized serial data interconnects, and a General purpose I/O (GPIO) circuit 2016 for parallel data input and output. These interface circuits are connected to the inter-module connectors via the cross point switches 2006 in order to provide flexibility and adaptability of interface assignments to the connectors of the circuit array module.

In addition to, or in place of, the microprocessor 2002 of the exemplary microprocessor circuit array module 2000, Field Programmable Gate Arrays (FPGAs), analog to digital circuits, digital to analog circuits or a mixture of analog and/or digital circuits are able to be incorporated within a circuit array module. Circuit array modules are also able to contain mechanical and/or programmable wiring. Some circuit array modules are also able to include circuits to stimulate and/or capture signals used for functional and performance verification of a targeted design. Circuit array modules are further able to contain onboard memory to retain one or more functional or routing configurations. Such circuit array modules are able to select from multiple configurations based upon the location of the circuit array module within the modular circuit array.

An example of the use of configuration files includes an application wherein one or more circuit array modules in a modular circuit array contain multiple configuration files in their non-volatile memories. Each circuit array module then selects a configuration based on the location in which it resides in the modular circuit array and on adjacent circuit array modules that are attached to that circuit array module. A second example in the use of multiple configuration files includes a software program that runs on a personal computer or workstation and that scans each circuit array module in a modular circuit array to determine the type of modules in the modular circuit array and each of their position. This software then determines the best possible routing for the logic circuit designs to be implemented by the modular circuit array. This software can then download target software into one or more microprocessors or digital signal processors in the circuit array modules, and the software on the workstation complies the design and downloads it to each circuit array module.

In these above examples, an engineer can work on a workbench with several circuit array modules spread out in the horizontal axis (X and Y). This allows the engineer to use lab equipment as well as EDA equipment to debug and verify the design.

Once the engineer is comfortable with a circuit design, the engineer can then take and rearrange the circuit array modules into a two dimensional Z axis array or into a three dimensional array allowing the engineer to make the array easy to transport for field testing.

Software applications and device driver interfaces are utilized by some embodiments to configure, query, stimulate, and analyze the functionality of the modular system. The software applications can query the modular array, store specific information related to each circuit array module, cross reference certain information related to each circuit array module in a local database, determine the wiring of the modular array, and textually and/or graphically describe the modular design to an end user.

The software application in the personal computer or workstation in these examples can also allow the end user to describe a circuit in graphical and/or textual format and the end user or the software application can then define the specific circuit array modules to be used to build the circuit. This software program can determine alternate configurations of which the implemented design can be constructed. This software application can also maintain a database of circuit designs for various configuration of each circuit array module with a revision history. The software application can further store and retrieve multiple configurations in each circuit array module while the circuit array module is operating in either a standalone configuration or while the circuit array module is assembled in the modular circuit array.

The application software on the personal computer or workstation, or a device driver interface, can be used to interface to third party tools in order to extend the functionality and capabilities of those tools. An example of a third party tool is a VHDL or Verilog simulator using a Programming Language Interface (PLI) to stimulate and verify the behavior of the circuit implemented in the modular array. A second example can be a circuit synthesis and place and route tool that can port a design directly to a circuit array module or multiple circuit array modules in a modular array.

Application Examples

One example of using an array of circuit array modules is the design, test and evaluation and verification of a logic circuit. As an example, an engineer designs a digital logic circuit and runs a software tool on a personal computer or workstation that interfaces to the modular circuit array to gather configuration information about the modular circuit array. The software tools on the personal computer or workstation are then used to synthesize, place, and route the design, and download the design into the modular circuit array. The modular circuit array and tools on the personal computer or workstation are then used to and perform verification of the design.

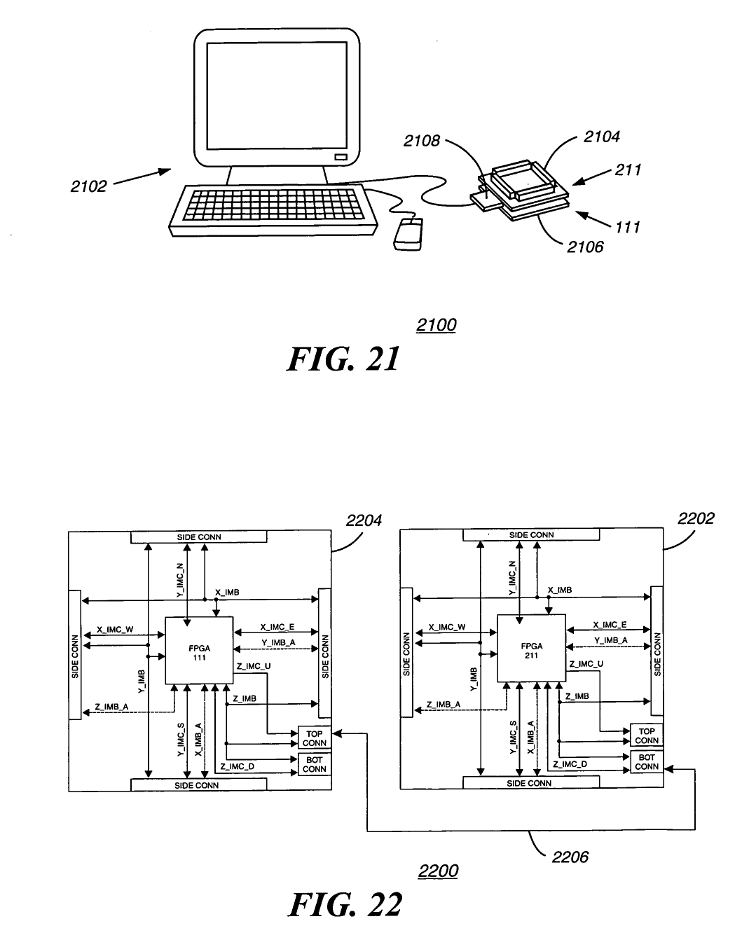

An exemplary workstation and modular circuit array configuration 2100 for this example is illustrated in FIG. 21. This configuration includes a workstation 2102, two circuit array modules, a module 211 2104 and a module 111 2106. The module 111 2106 is connected to the workstation 2102 via a configuration/data adaptor 2108. In this example, the engineer starts by entering a circuit design into the workstation 2102 with a conventional text editor or schematic capture software tool. For this example, the Verilog Hardware Descriptive Language is used. The engineer also creates a test bench that is behavioral at the top level, but also includes a synthesizable circuit that generates stimulus and receives and verifies the response from the device under test. These tools allow the entire design and verification has taken place using a software simulator that is readily available on the market.

After exhausting the capability of a software-based simulation, the engineer then selects two circuit array modules that meet the needs of his or her design criteria. In this case the two circuit array modules, module 211 2104 and module 111 2016, are FPGA circuit array modules. The engineer then attaches the two circuit array modules together as shown by stacking one circuit array module on top of the other causing the circuit array modules to encode, via the location determination circuits described herein, a location address of Module 211 on top, and Module 111 on the bottom, for module 211 2104 and module 111 2106, respectively. The Configuration/Data Interconnect Adaptor is then attached between the computer and Module 111 2106.

The design of the circuit array modules results in both the Configuration Interconnect (CI) and the Data Interconnect (DI) being connected together between circuit array modules. The engineer then runs an application that communicates with the modular circuit array and that first determines the number of circuit array modules that are available in the array. The application then interrogates each circuit array module in the modular circuit array and stores each circuit array module's parameters. The application then looks in a “module” library database and retrieves a “virtual” circuit array module for each physical circuit array module found in the array.

Of note is the fact that at this point, the engineer is not required to have the modular circuit array system available during the circuit array module planning stage and the engineer may manually select the circuit array modules to use and may further predefine the circuit array module arrangement.

Once the “virtual” circuit array modules' interconnect structure is determined, the application on the workstation 2102 then determines the location of each circuit array module with respect to other circuit array modules in the modular circuit array. In this example, there are only two circuit array modules and the application recognizes that these two circuit array modules are stacked in the vertical dimension. The application on the workstation 2102 then creates a netlist for the presently configured interconnect structure. This netlist is derived based upon the capabilities of the devices within each circuit array module and the interconnection capabilities of the circuit array modules that were identified in the modular circuit array.

An example of a circuit definition 2200 for the two circuit array modules in this example is illustrated in FIG. 22. The netlist that has been created for this example connects all signals from the Z_IMC_D connector (i.e., bottom connector) of module 211 2202 to the Z_IMC_U connector (i.e., top connector) of module 111 2204. The engineer then configures the application to retrieve the Verilog circuits that were tested on the test bench. The application executing on the workstation 2102 then displays a graphical representation showing the Verilog Hardware Descriptive Language circuits and the Modular Array modules.

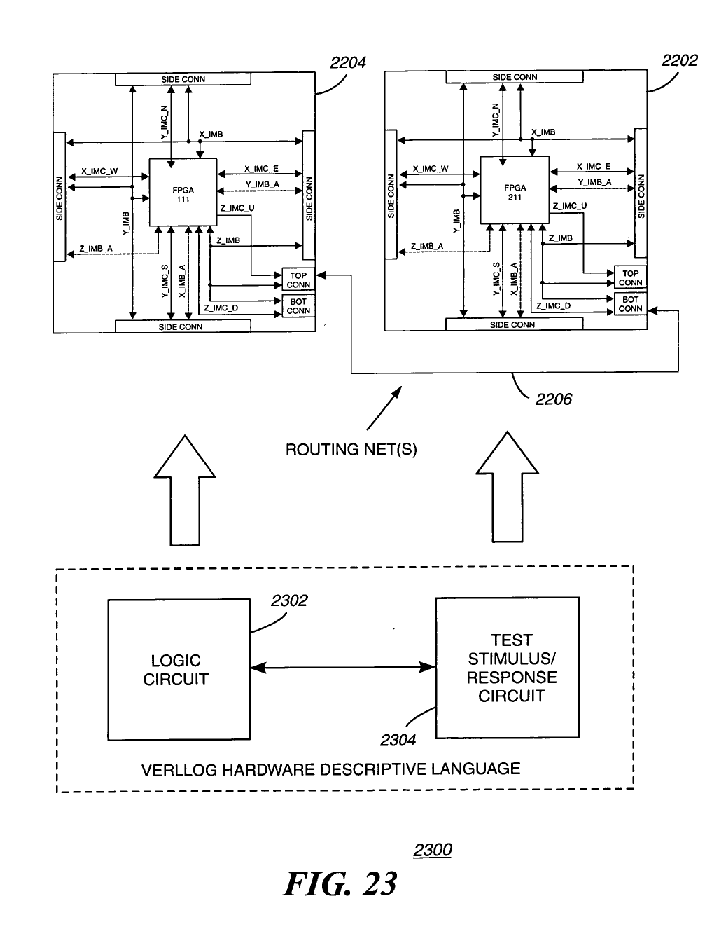

An exemplary development environment 2300 for this example application is illustrated in FIG. 23. The exemplary development environment has the two circuit array modules, module 111 2204 and module 211 2206, along with an interconnection 2206 that contains routing nets between the two circuit array modules. The engineer has developed a Verilog Hardware Descriptive Language (VHDL) logic circuit 2302, along with a test stimulus/response circuit 2304. The engineer is then able to allow the application executing on workstation 2102 to automatically place the VHDL circuits into the two physical circuit array modules, or the engineer is able to manually specify which circuits go into which circuit array module.

The application executing on the workstation 2102 then performs a mapping between the interconnections defined for the Verilog Hardware Descriptive Language modules and the interconnections to be made on the physical circuit array modules. The application executing on the workstation 2102 then generates a constraint file for each Verilog Hardware Descriptive Language circuit that will later be used by other applications during for synthesis and FPGA place and route. The application executing on the workstation 2102 then sequentially calls the circuit synthesis application on the workstation 2102 and an FPGA place and route application creates FPGA configuration files that can be downloaded into the modular circuit array modules.

At this point the engineer has the option of downloading the configuration files to each of the FPGAs located on the circuit array modules, or to a nonvolatile configuration memory located on each of the circuit array modules. When the configuration files are downloaded directly to the FPGA, the FPGA usually does not have non-volatile memory, so once power is lost or the FPGA is reinitialized, the configuration file no longer exists within the FPGA. When downloaded to onboard non-volatile memory the FPGA of the exemplary embodiment can advantageously be automatically loaded, if a valid downloaded configuration definition exists, after power is applied or the FPGA is reinitialized.

A further advantageous feature of the exemplary embodiments of the present invention is that the engineer is able to instruct the application executing on the workstation 2102 to create an alternative configuration or configurations that allow the circuit array modules to be swapped or placed side-by-side in a horizontal direction. The number of configurations a circuit array module can hold is only limited by the amount of non-volatile memory on that circuit array module. The configuration, location and arrangement of circuit array modules can be automatically determined, as is described herein, and the processing of the exemplary circuit array module is able to determine the proper configuration to select and configure based upon the circuit array module's location and adjacent circuit array modules.

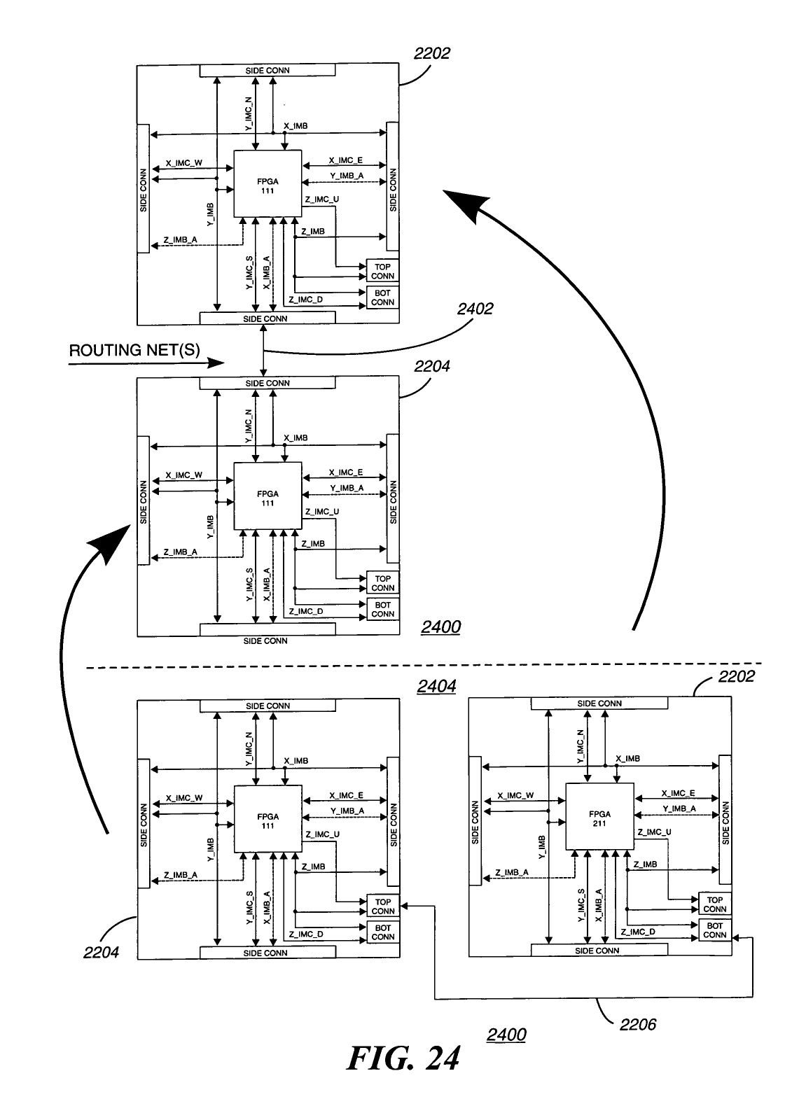

An exemplary modular circuit array reconfiguration 2400 according to this example is illustrated in FIG. 24. This exemplary modular array reconfiguration 2400 shows the original circuit array module configuration 2404, where the circuit array modules are located one on top of the other. The exemplary modular array reconfiguration then shows a rearranged the circuit array modules configuration 2406, where the circuit array module 211 2202 was disengaged from circuit array module 111 2204 and placed to the front of circuit array module 111 2204. After this reconfiguration, the prior circuit array module 211 2204 is identified with the same serial number, which is configured into the hardware itself, but the circuit array module is now identified with location identifier 121 due to its relocated position and operation of the location determination circuits within the circuit array module. The original circuit array module 111 2204 is therefore now identified as circuit array module 121. If alternative configurations were loaded into the onboard non-volatile memory of each circuit array module, the circuit array modules then use the location identification to retrieve and program their FPGA and other elements according to this different location data.

A new configuration, i.e., location, of one or more circuit array module does not necessarily change the internal functionality of the circuit within the circuit array module, but instead can only require a reroute of the module-to-module interconnection. In this example, the Y_IMC_N connector of the newly arranged module 111 would be routed to the Y_IMC_S connector of the newly arranged module 121. The new inter-module connector 2402 contains these interconnections to allow proper operation and interoperation of these two circuit array modules in this exemplary configuration. Such reconfigurations may, of course, also require reconfiguration of internal functionality of the circuit or other processing within the circuit array module.

As described earlier in this specification, the application executing on the workstation 2102 interrogated the modular circuit array to retrieve all parameters and locations of the circuit array modules. A serial number was also retrieved for each circuit array module as part of this interrogation.

Based on the engineers decision to create these other configurations, the application can create alternative module place and route constraints files for each location the circuit array module will be placed in, rerun the FPGA place and route application, and create additional FPGA configuration files for each circuit array module to correspond to these different locations. These various configurations can be selected at will by the engineer through commands to the circuit array modules. An example of the use of multiple configuration files includes performance evaluation and comparisons of alternative circuit designs with a practically “side-by-side” test by simply reconfiguring circuit array modules with the different circuit designs.

Each configuration file generated for a particular circuit array module is associated with a location and a serial number for that circuit array module. The application that executes on workstation 2102 can also store a multitude of configuration files for each circuit array module and can select the appropriate files for download to the circuit array modules after interrogation and determination of the rearranged location of the circuit array modules.

The rearrangement of circuit array modules is defined by the location, serial number, and the relative location of one circuit array module with respect to another circuit array module. The relative position indicates to a first circuit array module the direction in which an attached circuit array module is connected. For example, if a second circuit array module is connected to the left (west) side of a first circuit array module and the circuit array modules are then rearranged so that the second module is connected to the north of the first module, the first module's position in the array remains the same but the second module's position has changed. The first module must know to adapt to this new configuration and reroute the signals to a different side of the circuit array module, in this case from the left side to the north side.

When multiple configuration files are stored in the non-volatile memory of the circuit array modules that form a modular circuit array, the modular circuit array of the exemplary embodiments advantageously does not require a workstation to reconfigure the circuit array modules upon the reconfiguration of those circuit array modules. When power is reapplied to the circuit array modules after a reconfiguration, or when the circuit array modules are released from an initial state, the automatic configuration of the circuit array modules use the location determination circuits to derive a Location Identification that part of the parameters upon which the FPGA configuration is selected.

The Serial Number and the Location Identification then serve to allow a workstation that is connected to a reconfigured modular circuit array to determine how the modular circuit array has been reconfigured. The application executing on the workstation interrogates all of the circuit array modules upon startup of the reconfigured modular circuit array, thereby retrieving the parameters and locations of all circuit array modules.

In an alternative mode of operation, the circuit array modules within a reconfigured modular circuit array are queried and the types and location of the circuit array modules are determined. The application that executes on a workstation then retrieves the necessary configuration files for the circuit array modules and downloads those proper configuration files into the circuit array modules within the modular circuit array. If, for example, the FPGA configuration files have not yet been generated for a new arrangement of the circuit array modules, the application executing on the workstation can then automatically generate these new configuration files.

The ability to rearrange the circuit array modules and to allow automatic reconfiguration advantageously and substantially aids the development and verification of circuit designs and systems. In a laboratory environment, the modular circuit array can be configured in a horizontal manner for easy access with test probes. In a mobile environment, the circuit array modules can be configured in a vertical environment to taking less space. The rearrangement of the circuit array modules is also desirable when a circuit array module is located below another circuit array module and signals cannot be observed.

Embodiments of the present invention advantageously provide circuit array modules that can be assembled into one, two or three dimensional modular circuit arrays. These modular circuit arrays provide a flexible and adaptable processing platform that allows implementation of a wide variety of processing circuits or other implementations. Some embodiments of the present invention further provide a straightforward mechanism to allow circuit array modules to determine their position within a modular circuit array to facilitate configuration of the circuit array module based upon its location within the modular circuit array. Some modular circuit arrays of the exemplary embodiments further allow multiple configurations for the circuit array module to be stored in non-volatile memory within the circuit array module and a pre-determined configuration can be loaded into the circuit array module upon power-up or reset based upon a number of factors, including the location of the circuit array module within a modular circuit array and/or the location, type and/or connection position of adjacent circuit array modules.

A software system that operates on a workstation or other computer is also provided within some embodiments of the present invention that connects to a modular circuit array, or optionally to only one circuit array module, and allows the determination of the components of the modular circuit array, programming or configuration of some or all of the circuit array modules within the modular circuit array, and observation/control of the modular circuit array while executing an processing program or routine.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A circuit array module for interconnection with similar circuit array modules, the circuit array module comprising:
a module body comprising an electrical circuit, a top surface, a bottom surface, and four lateral surfaces;
at least one top connector located on the top surface;
at least one bottom connector located on the bottom surface; and
at least three side connectors, wherein at least one of the at least three side connectors is each located on a different surface of the four lateral surfaces,
wherein each of the at least one top connector, the at least one bottom connector and the at least four side connectors are suitable for connecting to an adjacent connector that is mounted on an opposite surface of a similar module body.

2. The circuit array module according to claim 1, wherein at least one of the at least one top connector, the at least one bottom connector and the at least four side connectors comprise electrical signal conductors.

3. The circuit array module according to claim 1, wherein at least one of the at least one top connector, the at least one bottom connector and the at least three side connectors couple signals that terminate within the module body.

4. The circuit array module according to claim 1, wherein at least one of
the at least one top connector,
the at least one bottom connector, and
the at least three side connectors
couple signals that are coupled to at least one connector located on a different surface of the module body.

5. A circuit array module, comprising:
a module body comprising a processor;
a configuration storage for storing a plurality of configuration definitions, wherein at least two of the plurality of configuration definitions define different configurations for the processor and wherein each configuration definition within the plurality of configuration definitions is associated with a specified identity;
an attribute detector for determining an attribute of the module body; and
a configuration selector for selecting a selected configuration definition from the plurality of configuration definitions depending on the attribute.

6. The circuit array module according to claim 5, wherein the attribute detector determines a serial number that is associated with the module body.

7. The circuit array module according to claim 5, wherein the attribute detector determines a module type of the module body.

8. The circuit array module according to claim 5, wherein the attribute detector determines at least one component that is available within the module body.

9. The circuit array module according to claim 5, wherein the processor comprises at least one of a programmable computer, a microprocessor, a micro-controller, a reduced instruction set computer and a digital signal processor.

10. The circuit array module according to claim 5, wherein the processor comprises at least one of a field programmable gate array, an analog to digital converter and a digital to analog converter.

11. The circuit array module according to claim 5, wherein the module body comprises at least one of a cross-point switch, a memory device, a programmable termination network, user circuit connections, test equipment connections and a wiring interconnect.

12. The circuit array module according to claim 5, wherein the configuration selector receives an attribute query command and transmits, in response to the command, at least one of a module identification, a module location, a description of module memory sizes and types, a module performance parameter and a module serial number.

13. The circuit array module according to claim 5, further comprising a connector for connecting the processor to an adjoining circuit array module.

14. The circuit array module according to claim 13, wherein the adjoining circuit array module is able to be connected to at least one additional circuit array module.

15. The circuit array module according to claim 14, wherein the identity depends on at least one of the adjoining circuit array module and the at least one additional circuit array module.

16. The circuit array module according to claim 13, wherein the connector conveys at least one of test stimulus data, response data and continuous data output.

17. The circuit array module according to claim 13, wherein the configuration selector further accepts a configuration command through the connector and wherein the selected configuration definition is selected based at least in part upon the configuration command.

18. The circuit array module according to claim 13, wherein the configuration storage receives additional configuration definitions for storage from the connector.

19. The circuit array module according to claim 13, further comprising:
a circuit location detector for receiving circuit location input information from the adjoining circuit array module and producing a circuit location indicator in dependence upon the circuit location input information, and wherein the attribute depends upon the circuit location indicator.

20. The circuit array module according to claim 19, further comprising at least one additional connector for at least outputting the circuit location output information.

21. The circuit array module according to claim 13, further comprising at least a second connector for connecting to at least a second adjoining circuit array module.

22. The circuit array module according to claim 15, wherein at least one signal communicated through the connector is further communicated through at least one of the at least one second connector.

23. The circuit array module according to claim 16, wherein the connector is located on a first surface of the module and at least one of the at least one second connector is located on a second surface of the module, wherein the second surface is opposite the first surface.

24. The circuit array module according to claim 21, wherein the configuration selector transmits the attribute through the connector.

25. The circuit array module according to claim 21, wherein an attribute descriptor is received through the connector and relayed through the second connector.

26. The circuit array module according to claim 21, wherein at least one signal received through the connector is processed by the processor to produce an output signal, and the output signal is transmitted through the second connector.

27. The circuit array module according to claim 21, wherein at least one signal is routed from the connector to the second connector, wherein the routing is based at least in part on the selected configuration definition.

28. A method for defining a plurality of circuit configurations for a reconfigurable module, the method comprising:
defining a first circuit configuration of a circuit for a first reconfigurable module, wherein the first reconfigurable module is able to connect to a second reconfigurable module at more than one of a plurality of locations and wherein the first circuit configuration depends upon the second reconfigurable module being connected to the first reconfigurable module at a first location within the plurality of locations; and
defining a second circuit configuration of the circuit for the first reconfigurable module, wherein the second circuit configuration depends upon the second reconfigurable module being connected to the first reconfigurable module at a second location within the plurality of locations.

29. The method according to claim 28, further comprising:
determining, via a query to the first reconfigurable module, a current connection location for the second reconfigurable module to the first module; and
setting the first location to the current location.

30. The method according to claim 28, further comprising:
downloading the first circuit configuration and the second circuit configuration to the first reconfigurable module; and
downloading a specification of the first location and of the second location to the first reconfigurable module.

31. A computer program product comprising computer-programming instructions for a reconfigurable module, the computer programming instructions comprising instructions for:
defining a first circuit configuration of a circuit for a first reconfigurable module, wherein the first reconfigurable module is able to connect to a second reconfigurable module at more than one of a plurality of locations and wherein the first circuit configuration depends upon the second reconfigurable module being connected to the first reconfigurable module at a first location within the plurality of locations; and
defining a second circuit configuration of the circuit for the first reconfigurable module, wherein the second circuit configuration depends upon the second reconfigurable module being connected to the first reconfigurable module at a second location within the plurality of locations.

32. The computer program product according to claim 31, further comprising instructions for:
determining, via a query to the first reconfigurable module, a current connection location for the second reconfigurable module to the first module; and
setting the first location to the current location.

33. The computer program product according to claim 31, further comprising instructions for:
downloading the first circuit configuration and the second circuit configuration to the first reconfigurable module; and
downloading a specification of the first location and of the second location to the first reconfigurable module.

34. A module circuit configuration system comprising:
a first circuit design tool for defining a first circuit configuration of a circuit for a first reconfigurable module, wherein the first reconfigurable module is able to connect to a second reconfigurable module at more than one of a plurality of locations and wherein the first circuit configuration depends upon the second reconfigurable module being connected to the first reconfigurable module at a first location within the plurality of locations; and
a second circuit design tool for defining a second circuit configuration of the circuit for the first reconfigurable module, wherein the second circuit configuration depends upon the second reconfigurable module being connected to the first reconfigurable module at a second location within the plurality of locations.

35. The module circuit configuration system according to claim 34, further comprising:
a module query tool for determining, via a query to the first reconfigurable module, a current connection location for the second reconfigurable module to the first module, and
wherein the first circuit design tool further sets the first location to the current location.

36. The module circuit configuration system according to claim 34, further comprising a circuit configuration downloader for:
downloading the first circuit configuration and the second circuit configuration to the first reconfigurable module; and
downloading a specification of the first location and of the second location to the first reconfigurable module.

37. A location determination circuit for determining a location of a module within a series of at least two modules, the location determination circuit comprising:
at least two input lines, wherein the at least two input lines have a sequential order;
at least two resistors, wherein each of the at least two resistors connects one of the at least two input lines to a first logic level; and
at least two output lines, wherein the at least two output lines have the sequential order,
wherein a lowest order output line of the at least two output lines is connected to a second logic level and wherein the remaining output lines of the at least two output lines are each connected to a one lower order input line of the at least two input lines.
